(19) United States
(12) Patent Application Publication
(10) Pub. No.: US 2025/0164345 A1
(43) Pub. Date: May 22, 2025

(54) DUTY CYCLE SWEEP FOR CPSD IDENTIFICATION OF RESONANCE FREQUENCIES TO MONITOR FOR RESONANT AMPLIFICATION OF VIBRATION

(71) Applicant: ORACLE INTERNATIONAL CORPORATION, Redwood Shores, CA (US)

(72) Inventors: Gerard WARRENS, Gilbert, AZ (US); Guang Chao WANG, San Diego, CA (US); Kenny C. GROSS, Escondido, CA (US); Matthew T. GERDES, Oakland, CA (US); Ruixian LIU, San Diego, CA (US)

(21) Appl. No.: 18/514,587

(22) Filed: Nov. 20, 2023

(51) Int. Cl. G01M 7/00

(52) U.S. Cl. CPC G01M 7/00

(57) ABSTRACT

Systems, methods, and other embodiments associated with ML-based detection of amplification of vibration due to resonance are described. In one embodiment, a method includes recording vibrations of a reference asset while the reference asset is operated based on a test pattern that sweeps over a range of workload for the reference asset. Cross power spectral densities between the recorded vibrations and the test pattern are determined at intervals to identify resonance frequencies of the reference asset. Vibrations of a target asset are monitored at the resonance frequencies with a machine learning model trained to generate estimated values at the resonance frequencies that are consistent with the reference asset. Resonant vibration amplification is detected based on a dissimilarity between vibration values for the target asset at the resonance frequencies and the estimated values. And, an electronic alert that the target asset is undergoing the resonant vibration amplification is generated.

### BACKGROUND

Operation of mechanical systems or assets often causes the systems to vibrate, often due to rotation of one or more components of the system. These vibrations may be amplified by resonance when the component rotates (or otherwise vibrates) at or near a resonant frequency (also known as a natural frequency) of the system. Resonant amplification of vibration can cause the operation of the system to become unreliable, accelerate failure of the system, or even directly damage the system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a resonance detection system associated with swept sine duty cycle and CPSD analysis for ML-based identification and characterization of resonance phenomena.

FIG. 2 illustrates one embodiment of a resonance detection method associated with swept sine duty cycle and CPSD analysis for ML-based identification and characterization of resonance phenomena.

FIG. 3 illustrates a line chart 300 that plots an example sine sweep workload against a time axis 310 and an intensity or amplitude axis 315.

FIG. 4 illustrates a three-dimensional surface chart of vibration amplitudes for operational frequencies of an example asset.

FIG. 5 illustrates one embodiment of a resonance detection framework for data collection, pre-processing, and monitoring associated with swept sine duty cycle and CPSD analysis for ML-based identification and characterization of resonance phenomena.

FIG. 6A illustrates an example of a Kiviat tube GUI representing a first point in time when the target system is not undergoing vibration resonance.

FIG. 6B illustrates the example of Kiviat tube GUI representing a second point in time when the target system is undergoing vibration resonance.

FIG. 7 illustrates an additional example method for resonance detection, Kiviat-based detection method.

FIG. 8 illustrates an embodiment of a computing system configured with the example systems and/or methods disclosed.

### DETAILED DESCRIPTION

Systems, methods, and other embodiments are described herein that employ a swept sine duty cycle and cross power spectral density (CPSD) analysis for machine learning based identification and characterization of resonance phenomena in engineering assets. In one embodiment, a resonance detection system determines resonance frequencies of the asset by operating the asset in the swept sine duty cycle and performing a frequency domain analysis of the vibrations, and then monitors those resonance frequencies with a machine learning (ML) model to detect resonant vibration amplification. More simply, a resonance detection system is operated across a range of operation to determine frequencies where vibration is amplified by resonance, and monitors those frequencies for excessive vibration.

In one embodiment, the resonance detection system may perform one or both of two phases for detection of unwanted resonance vibration: an ML training phase and a runtime monitoring phase. In one embodiment, in the training phase, the resonance detection system records vibrations from a reference device while the reference device is tested through a continuous range of workload and the resonance frequencies are identified by frequency domain analysis of overlap between workload and vibration. An ML model is then trained with vibration data at the resonance frequencies to estimate appropriate levels of resonant vibration. In one embodiment, in the runtime monitoring phase, vibrations from a target device are monitored at the resonance frequencies with the trained ML model. Where the ML estimates and monitored values differ, resonant amplification vibration has been detected, and an alert is generated. In one embodiment, the alert may be used to trigger actions, such as to adjust operation of the target device to eliminate the resonant amplification vibration.

Prior attempts to address resonant amplification vibration test for excessive vibration in response to discrete workloads, such as low, medium, and high, and attempted to detect the excessive vibration in univariate vibration data, without identifying and specifically monitoring resonance frequencies. In one embodiment, the resonance detection system improves detection of resonant amplification vibration by determining which vibration frequencies actually resonate due to workload. Identifying which frequencies are thus resonant frequencies allows for more sensitive and accurate detection of the resonance detection system improves detection of resonant amplification vibration. In one embodiment, the resonance detection system improves detection of resonant amplification vibration by evaluating a continuous range of workload to find resonances that may not be excited at discrete workloads. Sweeping through the continuous range of workload allows for more thorough or more complete identification of which frequencies are resonant in an asset.

It should be understood that no action or function described or claimed herein is performed by the human mind. No action or function described or claimed herein can be practically performed in the human mind. Any interpretation that any action or function described or claimed herein can be performed in the human mind is inconsistent with and contrary to this disclosure.

### Definitions

As used herein, the term “resonant vibration amplification” refers to an intensification of vibration that occurs where the vibration is close to a resonant (or natural) frequency of an asset.

As used herein, the term “asset” or “engineering asset” refers to a physical system, structure, device, machine, appliance, apparatus, or other physical construct; or a component or part thereof. Assets may include, for example, manufacturing equipment, aircraft engines, server computers, buildings, vehicles, and a wide variety of other physical objects that are subject to vibration due to operation.

As used herein, the terms “time series” and “time series signal” refer to a data structure in which a series of data points or readings (such as observed or sampled values) are indexed in time order. For convenience, a time series signal may be referred to herein simply as a “signal”. In one embodiment, the data points of a time series may be indexed with an index such as a point in time described by a time stamp and/or an observation number. A time series may be considered one “column” or sequence of data points over multiple points in time from one of several sensors used to monitor an asset. For example, a time series is one “column” or sequence of observations over time from one of N variables (such as from one sensor of an aircraft engine, server computer, vehicle, or other asset).

As used herein, the term “vector” refers to a data structure that includes a set of data points or readings (such as observed or sampled values) from multiple time series at one particular point in time, such as a point in time described by a time stamp, observation number, or other index. A vector may therefore be considered one “row” of data points sampled at one point in time from all sensors used to monitor an asset. A vector may also be referred to herein as an “observation”. For example, a “vector” is one row of observations from all N variables (such as from multiple (or all) sensors of an aircraft engine, server computer, vehicle, or other asset).

As used herein, the term “time series database” refers to a data structure that includes multiple time series that share an index (such as a series of points in time, time stamps, time steps, or observation numbers) in common. In one embodiment, the time series database is one form of a collection of time series signals. From another perspective, the term “time series database” refers to a data structure that includes vectors or observations across multiple time series at a series of points in time, that is, a time series of vectors. As an example, time series may be considered “columns” of a time series database, and vectors may be considered “rows” of a time series database. A time series database is thus one type of a set of time series readings. For example, a database or collection of sensed amplitudes from sensors of an aircraft engine, server computer, vehicle or other asset may be arranged or indexed in order of a recorded time for the amplitudes, thus making a time series database of the sensed amplitudes.

As used herein, the term “residual” refers to a difference or error between a value (such as a measured, observed, sampled, or resampled value) and an estimate, reference, or prediction of what the value is expected to be. In one embodiment, the residual may be an unsigned magnitude of the difference, also referred to as an “absolute error.” For example, a residual may be a difference between an actual, observed value and a machine learning (ML) prediction or ML estimate of what the value is expected to be by an ML model. In one embodiment, a time series of residuals or “residual time series” refers to a time series made up of residual values between a time series of values and a time series of what the values are expected to be.

As used herein, the term “Kiviat surface” refers to a two-dimensional shape defined in the plane of a Kiviat chart by values along the axes of the Kiviat chart. For example, a Kiviat surface may be a polygon bounded by lines between values on adjacent axes. In one embodiment, the Kiviat surface is described by a discrete data structure.

As used herein, the term “Kiviat chart” or “Kiviat plot” refers to a two-dimensional chart or diagram with three or more variables represented on axes radiating from a central point. In one embodiment, Kiviat chart used herein have equal angles between axes of the Kiviat chart. In one embodiment, the Kiviat chart is described by a discrete data structure.

### —Example Resonance Detection System—

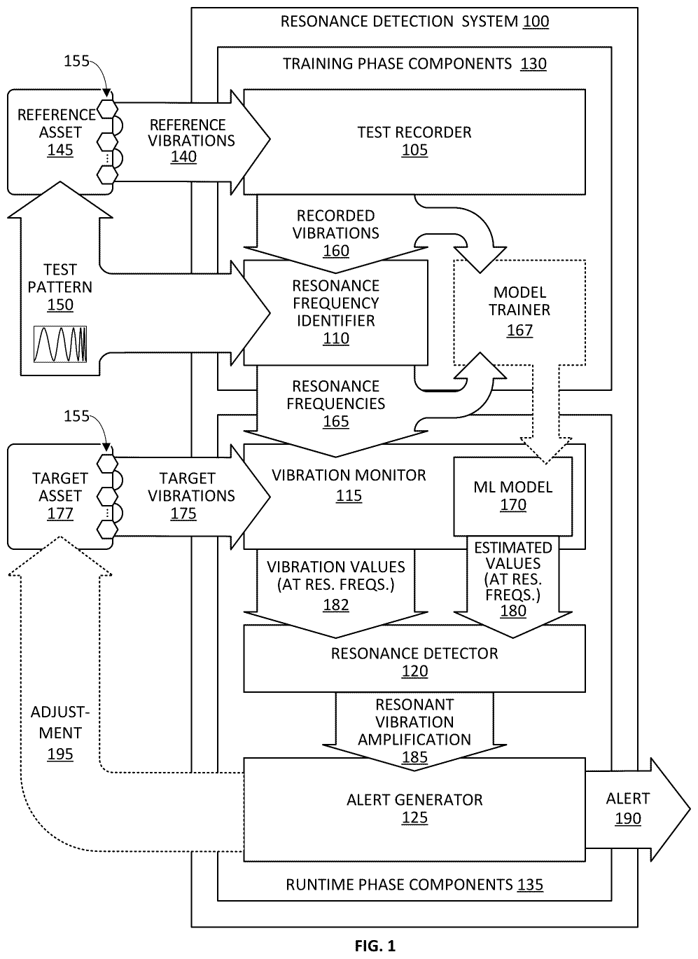

FIG. 1 illustrates one embodiment of a resonance detection system 100 associated with swept sine duty cycle and CPSD analysis for ML-based identification and characterization of resonance phenomena. Resonance detection system 100 includes components for detecting resonant vibration amplification in an asset. In one embodiment, components of resonance detection system include a test recorder 105, resonance frequency identifier 110, vibration monitor 115, resonance detector 120, and alert generator 125. In one embodiment, the test recorder 105 and resonance frequency generator 110 are training phase components 130 that operate in an initial training phase. And, in one embodiment, vibration monitor 115, resonance detector 120, and alert generator 125 are runtime phase components 135 that are operated in a subsequent runtime phase.

In one embodiment, test recorder 105 is configured to record vibrations 140 of a reference asset 145 while the reference asset 145 is operated based on a test pattern 150. A test pattern may also be referred to herein as a loading pattern, duty cycle, or workload profile. Test pattern 150 configures reference asset 145 to sweeps over a range of workload for the reference asset 145. In one embodiment, reference vibrations 140 of the reference asset 145 are acquired by one or more sensors 155 that are positioned on or about reference asset 145. In one embodiment, test recorder 105 is configured to provide test pattern 150 to reference asset 145, and further may be configured to control the operation of reference asset 145 to execute test pattern 150.

In one embodiment, reference asset 145 is controlled (by test recorder 105 and/or other control systems associated with reference asset 145) to operate according to the test pattern 150. For example, the test pattern 150 is a sine sweep of load across a range of operation for reference asset 145. In one embodiment, the sine sweep changes in periodicity linearly over the course of the sweep. In one embodiment, the sine sweep changes in periodicity non-linearly over the course of the sweep. More generally, the normal operational range of workload is identified, and the reference asset is operated though this range as a sweep.

In one embodiment, resonance frequency identifier 110 is configured to determine cross power spectral densities (CPSDs) between the recorded vibrations 160 and the test pattern 150. The resonance frequency identifier 110 is configured to determine the CPSDs at intervals (of time of the sine sweep) in order to identify resonance frequencies 165 of the reference device. The CPSDs are determined at intervals because different workloads over the course of the sine sweep may excite different resonances in the reference asset 145. In one embodiment, model trainer 167 is configured to train a machine learning model 167 based on the recorded vibrations 160 that are at the resonance frequencies 165 (once the resonance frequencies 165 have been identified.

In one embodiment, vibration monitor 115 is configured to monitor target vibrations 175 of a target asset 177 at the resonance frequencies 165 with the machine learning model 170. Machine learning model 170 is trained to generate estimated values 180 at the resonance frequencies that are consistent with the reference asset 145. In one embodiment, vibration monitor 115 is configured to sample vibration values 182 at the resonance frequencies 165 from the target vibrations 175. In one embodiment, the reference asset 145 and target asset 177 are two discrete assets having a similar or same type or configuration. In one embodiment, the reference asset 145 and target asset 177 are a same asset.

In one embodiment, resonance detector 120 is configured to detect resonant vibration amplification 185 based on a dissimilarity between the vibration values 182 for the target asset 177 at the resonance frequencies and the estimated values 180. In one embodiment, an extent of dissimilarity that indicates the presence of resonant vibration amplification is determined based on an annular residual area between kiviat plots of the vibration values 182 and the estimated values 180. and In one embodiment, an extent of dissimilarity that indicates the presence of resonant vibration amplification is determined by applying a sequential probability ratio test to the vibration values 182 and the estimated values 180.

In one embodiment, alert generator 125 is configured to generate an electronic alert 190 that the target device is undergoing the resonant vibration 185. In one embodiment, alert generator 125 is configured to perform an adjustment 195 to workload on the target asset 177 to reduce stimulus to the resonance frequencies. In one embodiment, alert generator 125 is configured to generate a graphical user interface that displays the alert 190 and/or information related to a status of resonant vibration amplification 185.

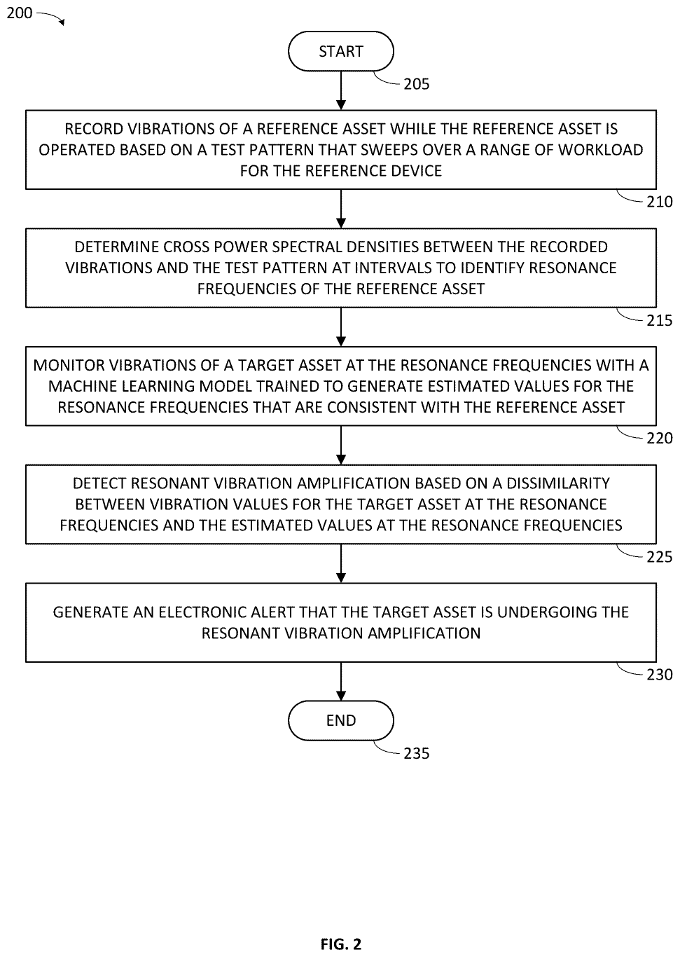

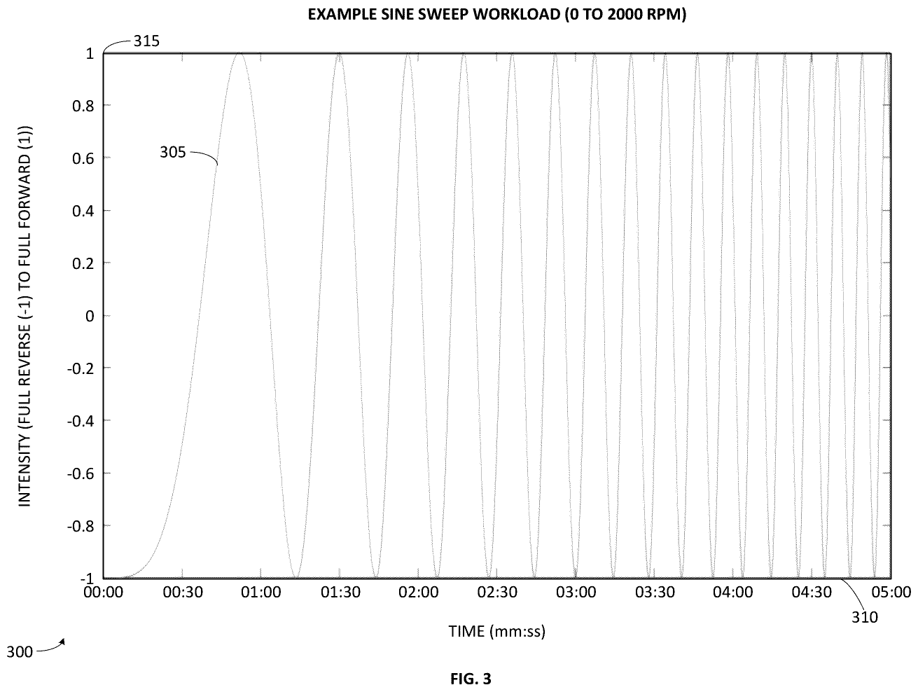

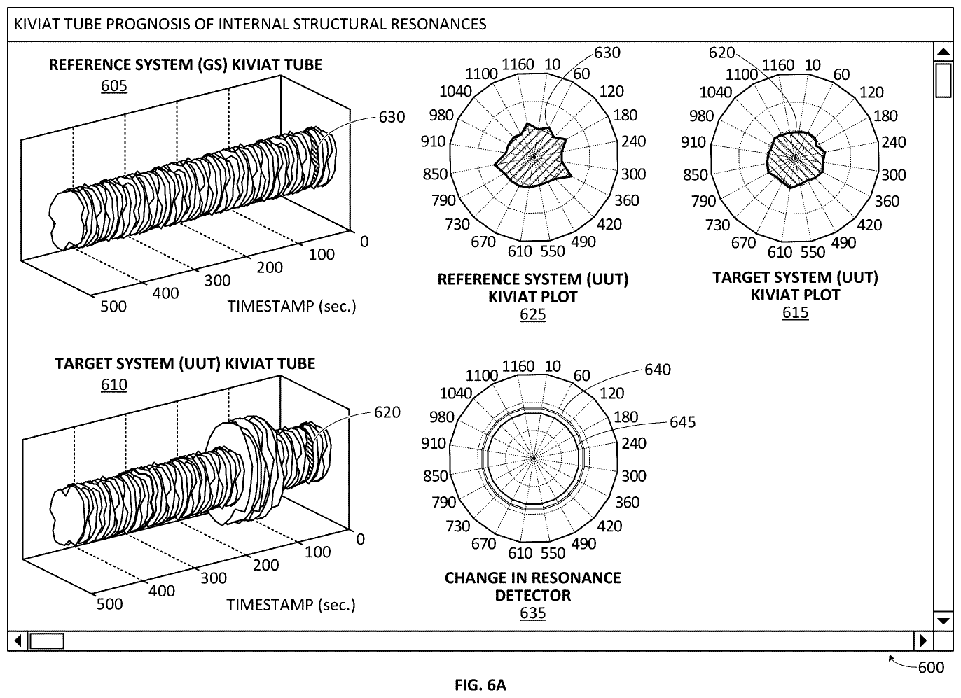

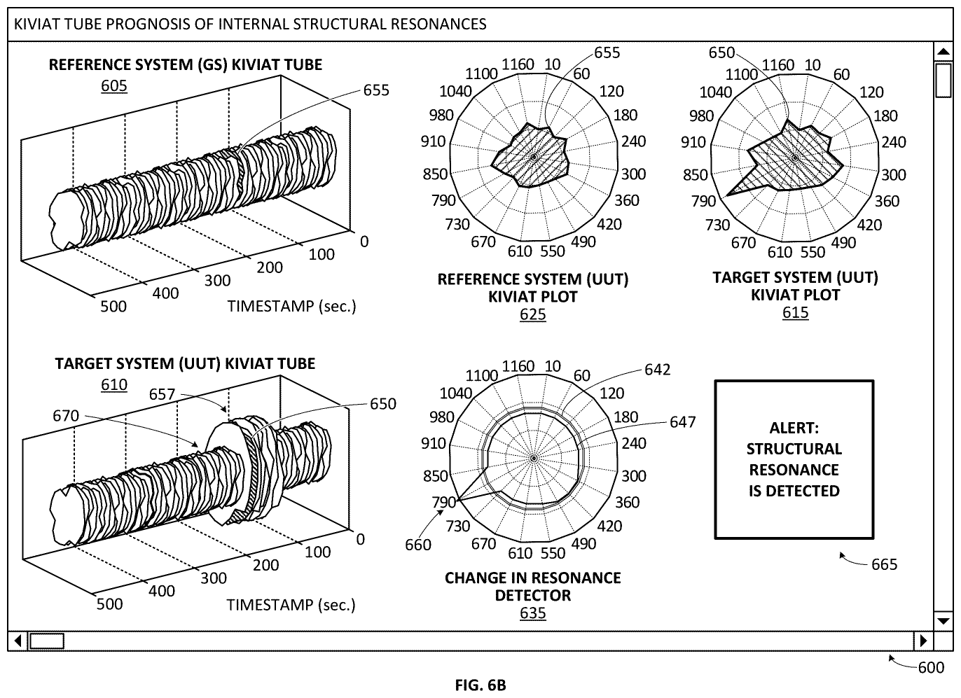

Further details regarding resonance detection system 100 are presented herein. In one embodiment, operations of resonance detection system 100 will be described with reference to methods 200, 500, and 700 of FIGS. 2, 5, and 7, respectively. In one embodiment, a sine sweep workload used as a test pattern by resonance detection system 100 will be described with reference to FIG. 3. In one embodiment, a graphical user interface to resonance detection system 100 with reference to FIGS. 6A-6C.

### —Example Resonance Detection Method—

FIG. 2 illustrates one embodiment of a resonance detection method 200 associated with swept sine duty cycle and CPSD analysis for ML-based identification and characterization of resonance phenomena. Resonance detection method 200 is one example process by which a ML model may be trained to identify excessive vibration due to resonance, and then used to detect such resonant vibration amplification in ongoing operations.

In one embodiment, as a general overview, resonance detection method 200 senses vibrations on a reference asset that is executing a test pattern of load (operating speeds). Overlapping frequencies between load and the vibrations are identified as resonance frequencies of the reference asset. Vibration values from the reference asset at the resonance frequencies are then used to train the ML model to estimate appropriate vibration values for assets of similar configuration to the reference asset. Vibrations from operation of a target asset are then monitored at the reference frequencies by the trained ML model to show how much vibration levels differ from expected values at the reference frequencies. Where the dissimilarity is too high, resonant amplification vibration is detected, and an alert is generated.

In one embodiment, resonance detection method 200 initiates at START block 205 in response to a resonance detection system (such as resonance detection system 100) determining one or more of (i) that a resonance detection system has been instructed to train an ML model to estimate vibration levels at the resonance frequencies that are expected when resonant amplification is not occurring; (ii) that a resonance detection system has been instructed to monitor vibrations of a target asset for resonant amplification of the vibrations; (iii) that an instruction to perform resonance detection method 200 has been received (iv) a user or administrator of a resonance detection system has initiated resonance detection method 200; (v) it is currently a time at which resonance detection method 200 is scheduled to be run; or (vi) that resonance detection method 200 should commence in response to occurrence of some other condition. In one embodiment, a computer system configured by computer-executable instructions to execute functions of resonance detection system 100 executes resonance detection method 200. Following initiation at start block 205, resonance detection method 200 continues to block 210.

At block 210, resonance detection method 200 records vibrations of a reference asset while the reference asset is operated based on a test pattern of duty cycle or workload that sweeps over a range of workload for the reference asset. The reference asset is run in accordance with the test pattern, and the vibrations produced by running the test pattern are sensed by sensors (such as accelerometers), transmitted to the test recorder, and written to memory or otherwise stored. Thus, the vibrations that are produced while the reference asset is operated as prescribed by the test pattern are captured by the resonance detection method 200. Resonance detection method 200 records how the reference asset vibrates and resonates under the various workloads imposed by the test pattern.

In one embodiment, the reference asset is an instance of a given type (make, model, configuration, etc.) that has been selected to be a standard of operation for assets of the given type. The reference device is used as a source of vibration readings of how assets of the given type are expected to vibrate during operation over a range of workload. The expected vibration is associated with a known extent of degradation of the asset. Generally, in one embodiment, the reference asset is confirmed to be free of degradation. For example, the reference asset may be confirmed to be free of defects due to wear, aging, damage, or other degradation modes. And, for example, the reference device may be confirmed to be configured according to specifications. Further, for example, the reference device may be confirmed to be provided with inputs specified for assets of the given type, such as fuels, lubricants, feedstocks, power supply, etc. The reference device is thus at a state of degradation that is known-confirmed empirically by observation. Vibration sensor readings taken while the reference asset is being operated will therefore represent expected behavior by assets of the given type that are in an undegraded (or other known) state of degradation.

In order to identify potentially hidden resonance frequencies of the reference asset, the reference is operated based on a test pattern. The test pattern is a deterministic (that is, pre-determined) sequence of varying workload levels placed on the reference asset over a period of time. The test pattern causes the workload on the reference device to sweep over a range of operation for the reference device. Because the sweeping workload causes vibration of the reference device to pass through a range of vibration frequencies, the frequency of the vibration will occasionally pass through resonance frequencies of the reference asset. Consequently, the sweeping workload will drive resonant amplification of the vibrations of the reference asset where the workload stimulates the resonance frequencies, thereby revealing the presence of the resonance frequencies.

In one embodiment, the resonance detection system controls the operation of the reference asset to cause the reference asset to operate according to the test pattern. For example, the resonance detection system may throttle or control the power supplied to the reference asset in order to cause the workload of the reference asset to follow the test pattern. In one embodiment, the resonance detection system may issue electronic instructions to a controller of the references asset in order to cause the reference asset to vary its workload as specified by the test pattern. In one embodiment, the test pattern is a sine sweep of load that covers a range of operation for the reference asset. And, in one embodiment, the sine sweep changes in periodicity (for example changing linearly) over the course of the sweep. Additional detail regarding the test pattern is discussed below under the heading “Sine Sweep” and with respect to FIG. 3.

In one embodiment, resonance detection method 200 records the vibrations of the reference asset that were generated by operating the reference asset in accordance with the test pattern. In one embodiment, the vibration sensor readings are electrical signals or amplitude values produced by sensors. In one embodiment, resonance detection method 200 time writes the vibration sensor readings to memory or storage for subsequent processing. In one embodiment, resonance detection method 200 characterizes a broad frequency spectrum of the vibration sensor readings. In one embodiment, the vibration sensor readings are converted to an amplitude waveform over the spectrum of frequencies. For example, a fast Fourier transform (FFT) is performed to produce the amplitude waveform. In one embodiment, a series of amplitude waveforms are produced at a sampling interval of time. The vibration sensor readings are thus characterized or represented over time as a series of amplitude waveforms across the frequency spectrum. In one embodiment, the conversion of the sensor readings to an amplitude waveform (such as by FFT), and other operations for characterization of the frequency spectrum may be performed by a spectrum analyzer. The spectrum analyzer may be a spectrum analysis software module or component that may be executed on a variety of hardware. The spectrum analysis software module may execute, for example, on the computing device(s) that operate resonance detection system 100, on a stand-alone spectrum analyzer device, on an input/output handler for the sensors 155, on a computing device of a data acquisition system that gathers vibrations from the sensors 155, or on other hardware.

Thus, in one embodiment, resonance detection method 200 records vibrations of a reference asset that are produced by the reference asset when the reference asset is operated based on the sweep test pattern by causing the reference asset to operate according to the test pattern, accessing vibration sensor readings detected while the reference asset operates as provided by the test pattern, converting the vibration sensor readings into a time series of amplitude waveforms on a spectrum of frequencies, and placing the time series of amplitude waveforms into memory or storage. In one embodiment, the activities of process block 210 are performed by test recorder 105.

At block 215, resonance detection method 200 determines cross power spectral densities (CPSDs) between the recorded vibrations and the test pattern at intervals to identify resonance frequencies of the reference asset. In other words, the resonance detection method 200 determines a bivariate power spectral density curve between the workload (or duty cycle) driving the reference asset and the vibration signals from the vibration sensors. In one embodiment, resonance detection method 200 amplifies resonant frequencies of the reference asset in the frequency domain where the frequency of the driving workload and the vibration readings are correlated. This enables ready detection of the resonant frequencies in the frequency domain.

The CPSD between two signals is a measure of how the power of one signal relates to the power of another signal across a spectrum of frequencies. Peaks in the CPSD of two signals show the frequencies at which the activity of the two signals is correlated. CPSDs between the recorded vibrations and the test pattern can be used to detect and characterize the resonant frequencies of the reference asset. In particular, structural resonances of the reference asset that are driven or stimulated by the workload (or duty cycle) specified by the test pattern form tall peaks in the CPSD. Frequency components that are shared between the duty cycle and the vibrations are intensified, while random noise and other frequency components that are not shared between the duty cycle and vibrations are suppressed. The CPSD emphasizes the frequencies where the duty cycle and vibrations coincide, thereby identifying resonance frequencies of the reference asset.

In one embodiment, the CPSD of the test pattern and the recorded vibrations is determined by computing a Fourier transform of the test pattern and a Fourier transform of the recorded vibrations, computing a cross-correlation of these two Fourier transforms, and normalizing the cross-correlation by the product of the PSD of the duty cycle and the PSD of the recorded vibrations. The CPSD may then be plotted to visualize the frequency domain relationship between the duty cycle and the vibrations.

In one embodiment, a series of CPSDs are generated for the recorded vibrations and the test pattern. Each CPSD in the series is performed for a window (that covers a range of time) of the recorded vibrations and the test pattern. The window is a moving window that advances by an increment of time for each CPSD. Thus, the CPSDs are determined at intervals. A CPSD for a window shows the effect of the particular part of the duty cycle that is being performed during the window on the vibrations produced by the asset during the window. In one embodiment the series of CPSDs is stored as a time series of CPSDs that is time-indexed at the increments by which the window is advanced. Additional detail about the CPSD analysis is discussed elsewhere herein, for example under the heading “Sine Sweep” and in DSP phase 505 of resonance detection framework 500.

In one embodiment, resonance detection method 200 identifies resonance frequencies of the reference asset based on the series of CPSDs for the windows. As discussed above, the CPSDs span a frequency spectrum of vibrations. In one embodiment, the frequency spectrum covers a range of frequencies between the lowest speed at which a component of the reference asset can rotate (e.g., 0 RPM) and a highest speed at which a component of the reference asset can rotate. In one embodiment, resonance detection method 200 subdivides or partitions the frequency spectrum of the CPSDs into a plurality of bins. The bins are contiguous sub-ranges of frequency within the frequency spectrum of the CPSDs. In one embodiment, the bins are discrete with respect to one another and do not overlap. In one embodiment, the bins have approximately equal width. The bins may be referred to as “coarse” bins because they contain more than one frequency.

The frequencies included in a bin may not all carry information about vibrations, for example, some frequencies may carry little more than noise. But frequencies that represent vibrations are often correlated with each other in behavior. Therefore, in one embodiment, resonance detection method 200 averages correlated frequencies in each bin over the intervals to produce averaged bins. The correlated averaging reduces the data size taken to represent the frequency bin from many frequencies to one frequency. The correlated averaging also removes noise from the bin by disregarding frequencies that are uncorrelated noise, and by averaging the values of the correlated frequencies, thereby smoothing out spikes of noise.

A time series of the correlated average values in an individual bin may be sampled from the CPSDs. The time series of correlated averages from a bin are a compact representation of vibration amplitude over time in the frequency range of the bin. In one embodiment, resonance detection method 200 samples a time series from each averaged bin. The amplitude of power spectral density for the time series represents an extent to which the correlated frequencies of the bin represented by the time series are driven by resonance. Therefore, to determine the extents of resonance, resonance detection method 200 determines amplitude for the bins from the sampled time series. In one embodiment, the amplitudes for the bins are found by calculating the PSD of the time series sampled from the bin, and determining the height of the tallest peak in the PSD waveform. Resonance detection method 200 then selects the bins which are in a top range or portion of amplitude to be the resonance frequencies. For example, the top 20 bins out of 100 total bins.

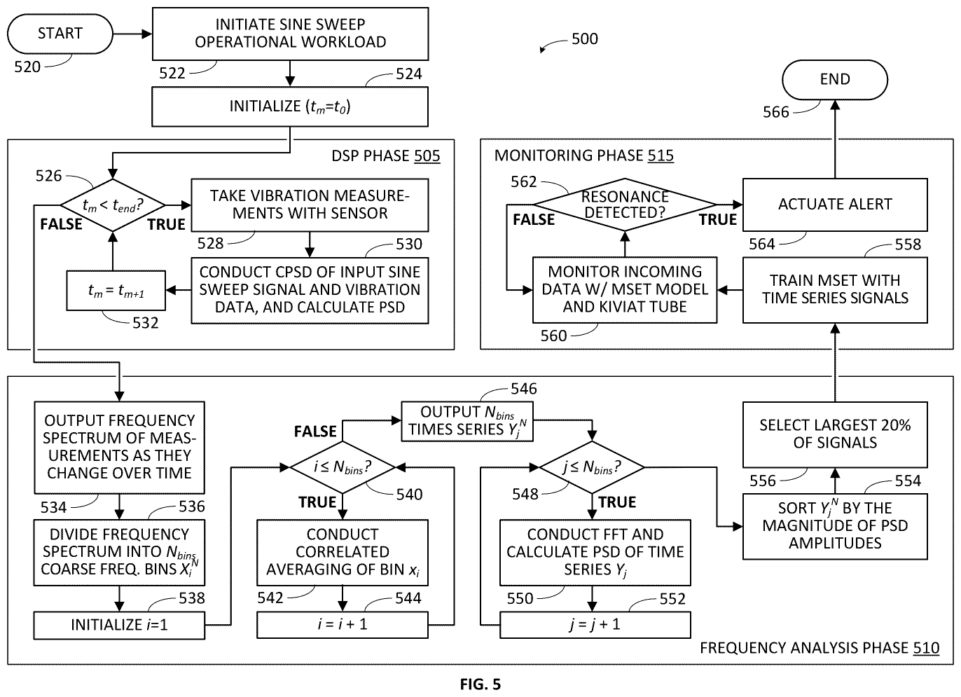

Additional detail about partitioning the frequency spectrum into bins, correlated averaging of frequencies in the bins, generating time series for the bins, and selecting the resonance frequencies is provided elsewhere herein, for example under the heading “Frequency Binning and Resonant Frequency Time Series Generation” and with reference to frequency analysis phase 510 of FIG. 5.

Thus, in one embodiment, the resonance detection method 200 computing CPSDs between the recorded vibrations and test pattern in a moving window to produce a time series of CPSDs, partition the frequency spectrum for the CPSDs into bins, extract the correlated activity within the bins, identify the “loudest” bins (bins that have greatest amplitudes of correlated activity) to be the resonant frequencies of the reference asset, and store identifications of the loudest bins and the correlated frequencies of those bins for subsequent processing. In one embodiment, the activities of process block 215 are performed by resonance frequency identifier 110.

At block 220, resonance detection method 200 monitors vibrations of a target device at the resonance frequencies with a machine learning model trained to generate estimated values at the resonance frequencies that are consistent with the reference asset. The monitoring finds the differences or residuals between what the amplitudes of the resonance frequencies are expected to be, and what the amplitudes of the resonance frequencies actually are observed to be.

In one embodiment, resonance detection method trains the machine learning model to produce estimates for each resonant frequency that are consistent with nominal behavior of the reference asset. In an example automatic training operation, the machine learning model parses time series of the values of the resonant frequencies observed from the reference asset. The automatic training operation adjusts a configuration of the ML model to cause the ML model to produce estimated vibration values for the resonant frequencies that closely approximate the observed vibration values of the resonant frequencies. The training causes the machine learning model to be configured to produce estimates of what the vibration at each individual resonant frequency is expected to be based on the actual, observed vibration values of the resonant frequencies other than the individual resonant frequency. The trained ML model is then stored for subsequent use to monitor vibrations of a target device at the resonant frequencies. Additional detail on training of the machine learning model to detect an anomaly is provided below under the heading “Overview of Multivariate ML Anomaly Detection”.

In one embodiment, resonance detection method 200 then generates vibration time series for the resonant frequencies of the target asset. Raw vibration measurements are obtained from the target asset. The vibration measurements may be vibration sensor signals received live, in real-time from the target asset, or retrieved from storage. The vibration measurements from the target asset are processed to convert them into a time series of PSD curves-amplitude waveforms across the frequency spectrum of the vibration measurements. For example, resonance detection method 200 performs a series of FFTs on the raw vibration measurements of the target asset to produce the time series of PSD curves. The bins previously applied to partition the time series of CPSDs for the reference asset (at block 215) are also applied to the time series of PSD curves for the target asset. The resonant frequency bins previously selected for the reference asset (as discussed above at block 215) are also selected for monitoring the target asset. In one embodiment, the amplitude of a resonant frequency bin is represented by the correlated average of the frequencies in the resonant frequency bin (as discussed above at block 215). The amplitude of each resonant frequency bin is sampled or observed at an interval to produce a vibration time series for each resonant frequency of the target asset. This raw-vibration-to-vibration-time-series process may be repeated indefinitely in batches to provide a stream of values for the vibration time series for the resonant frequencies.

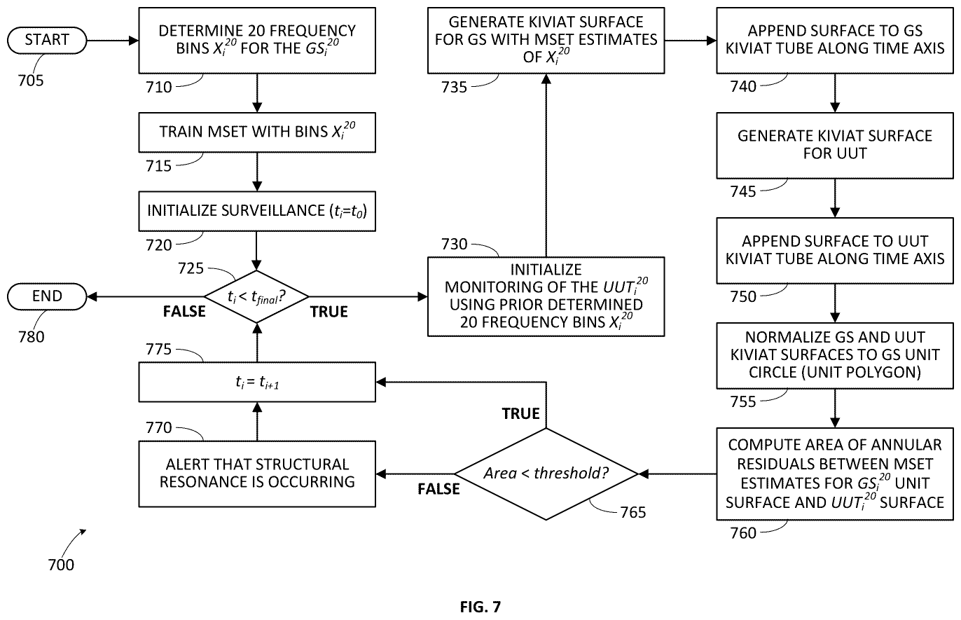

In one embodiment, once the machine learning model is trained and the vibration time series obtained, the machine learning model may be used to monitor the vibration time series for the resonant frequencies of the target asset. In one embodiment, resonance detection method 200 uses the trained ML model to generate a time series of residuals between model-estimated vibration values and actual vibration values for each resonance frequency. Thus, time series of residuals are generated for multiple resonance frequencies. For example, resonance detection method 200 finds the differences between data points in the time series of observations from the bins and data points at corresponding indexes in a time series of estimates by the trained ML model, and stores the differences or residuals in a time series of residuals at the corresponding indexes. One or more of the time series of residuals may be provided to an anomaly detection model such as SPRT or annular area of Kiviat surface test to detect when deviations from expected signal values are anomalous, as discussed in further detail below in block 225, and with reference to FIG. 7.

Thus, in one embodiment, resonance detection method 200 monitors vibrations by training a machine learning model to produce estimates of what the vibration levels are expected to be at the resonant frequencies, converting raw vibration sensor readings of the target asset into vibration time series for the resonant frequencies of the target asset, generating estimates of vibration levels at the resonant frequencies, and recording the differences between the estimated and observed values. In one embodiment, the activities of process block 220 are performed by vibration monitor 115.

At block 225, resonance detection method 200 detects resonant vibration amplification based on a dissimilarity between vibration values for the target asset at the resonance frequencies and the estimated values. For example, resonance detection method 200 may detect the presence of resonant amplification of vibration based on differences or residuals between the levels of vibration observed for the target vehicle and the expected levels of vibration. Where the level of dissimilarity is sufficiently large, the level of dissimilarity indicates excessive resonant amplification of vibration is occurring in the target asset.

In one embodiment, the dissimilarity is detected based on analysis of one or more Kiviat plots of the values of the resonant frequencies. Resonance detection method 200 accesses the vibration values for one observation of the resonance frequencies. Resonance detection method 200 also accesses the estimated values for the observation of the resonance frequencies. Resonance detection method 200 then plots the monitored values and the estimated values onto a Kiviat diagram. This forms a kiviat surface defined by the position of the vibration values along the axes of the Kiviat diagram.

Resonance detection method 200 then normalizes the Kiviat surface to a unit circle of the estimated values. In other words, the positions of the vibration values on the axes of the Kiviat diagram are scaled by coefficients that cause the position of the estimated values along the axes to be scaled to a unit, i.e., 1. Resonance detection method 200 generates an annular residual between the normalized vibration values for the target asset and the normalized estimated values, or unit circle. The annular residual is the absolute area between the unit circle and the normalized vibration values for the target asset.

Resonance detection method 200 then compares the annular residual to a threshold for detecting that resonant amplification of vibration is occurring in the target. In one embodiment, resonant amplification of vibration is detected to be occurring when the area of the annular residual exceeds the threshold. In one embodiment, the threshold is a portion of the area of the unit circle, such as 5% of the area of the unit circle.

Thus, in one embodiment, resonance detection method 200 detects resonant vibration amplification as follows: Amplitude values at the resonant frequencies for vibrations of the target asset are accessed. The amplitude values and plotted onto Kiviat diagram as points along the axes for the resonant frequencies. The points on adjacent axes are connected to define a Kiviat surface of the vibrations of the target asset. Estimates for the amplitude values at the resonant frequencies are generated by the trained ML model based on input of the actual amplitude values. The target kiviat surface is normalized by scaling the points on the axes to cause the estimates for the amplitude values to be at the unit positions on the axes. A residual area between the unit circle and the normalized Kiviat surface is determined. The residual area (also referred to as an “annular residual”) is evaluated against a condition, such as whether or not a threshold is exceeded. Where the condition is satisfied, is exceeded, resonant amplification of vibration is detected, and an alert may be generated as discussed below.

In one embodiment, the dissimilarity is detected based on SPRT analysis of a series of values of one or more of the resonant frequencies. As discussed above, in one embodiment, a series of residuals has been generated. The residuals are between monitored values of the monitored vibrations and the estimated values for one or more of the resonance frequencies. In one embodiment, resonance detection method 200 detects an anomaly in the series of residuals with a sequential probability ratio test in order to detect the dissimilarity. Additional details on the execution of the SPRT analysis is discussed below, under the heading “Overview of Multivariate ML Anomaly Detection”. In one embodiment, the activities of process block 225 are performed by resonance detector 120.

At block 230, resonance detection method 200 generates an electronic alert that the target asset is undergoing the resonant vibration amplification. In one embodiment, the electronic alert is generated by composing and transmitting a computer-readable message including content describing the resonant amplification of vibration in the target asset. In one embodiment, the electronic alert indicates the resonant frequency or frequencies at which the amplification is occurring. In one embodiment, the electronic alert indicates a timestamp or range of time during which the resonant amplification of vibration is occurring. In one embodiment, the electronic alert may include instructions or a hyperlink to instructions describing how to remediate the resonant amplification in the target device. These instructions may be maintained in a database and presented to a user in response to the electronic alert.

In one embodiment, the electronic alert may be composed and then transmitted for subsequent presentation on a display or other action. The electronic alert may be configured to be presented by display in a graphical user interface (GUI). Further detail regarding display of the electronic alert in a GUI is discussed below, for example with reference to FIGS. 6A and 6B under the heading “Example GUI for Resonance Detection System”.

In one embodiment, the electronic alert may be used to cause an automatic adjustment to the operating workload of the target asset. The electronic alert may be received by a controller of the target asset. The electronic alert may be configured to cause the controller of the target asset to alter the workload of the target asset to avoid stimulating a resonant frequency. For example, upon receiving the alert, a fan controller of a server computer may throttle fan speeds to avoid driving resonant frequencies of the server's chassis.

Additional detail regarding electronic alerting is discussed below, under the heading “Electronic Alerts”. In one embodiment, the activities of process block 230 are performed by alert generator 125.

At the conclusion of process block 230, resonance detection method 200 Proceeds to END block 235, where resonance detection method 200 concludes. In one embodiment, blocks 210-215 make up an offline training phase for configuring the ML model. And, in one embodiment, blocks 220-230 make up a runtime monitoring or detection phase for detecting resonant vibration amplification for operations of a target asset.

### Further Embodiments of Example Resonance Detection Method

In one embodiment, resonance detection method 200 further controls the operation of the reference asset to cause the reference asset to operate according to the test pattern. In one embodiment, the test pattern is a sine sweep of load that covers a range of operation for the reference asset. In one embodiment, the sine sweep changes in periodicity over the course of the sweep. For example, the sine sweep may change in periodicity linearly over the course of the sweep.

In one embodiment, resonance detection method 200 identifies the resonance frequencies of the reference asset (as discussed above at block 215) using a frequency analysis. In one embodiment, the frequency analysis subdivides the frequency spectrum of the cross power spectral densities into a plurality of bins. The frequency analysis then averages the values in each bin over the intervals to produce averaged bins. The frequency analysis samples a time series from each bin and determine power spectral density for the bins. The frequency analysis then selects the bins which have a power spectral density in a top range of amplitude to be the resonance frequencies.

In one embodiment, resonance detection method 200 further automates corrective action to diminish or remove excessive vibration due to resonance. For example, in response to the electronic alert (discussed above at block 230), resonance detection method 200 further triggers an adjustment to workload on the target asset to reduce stimulus to the resonance frequencies. Thus, in response to the electronic alert, resonance detection method 200 operation of the target asset to reduce stimulus to the resonance frequencies. Or, for example, in response to the electronic alert, resonance detection method 200 generates and transmits instructions for service to remediate the resonant vibration amplification. In one embodiment, the instructions accompany transmission of the electronic alert. In one embodiment, the instructions are accessible through a display of the alert, for example by a including a hyperlink to the instructions in the alert. For example, the system may progressively throttle speeds of one or more components of the asset up or down until the resonant amplification of vibration is no longer detected. Thus, the asset may continue to operate under the adjusted speeds, for example until other repairs may be carried out.

In one embodiment, resonance detection method 200 detects resonant vibration amplification (discussed above at block 225) based on an annular residual between kiviat plots of the vibration values and the estimated values satisfying a condition for detecting the resonant vibration amplification. In one embodiment, resonance detection method 200 detects resonant vibration amplification using a monitoring process. In one embodiment, the monitoring process accesses monitored values of the monitored vibrations for an observation of the resonance frequencies and the estimated values for the observation of the resonance frequencies. The monitoring process then plots the monitored values and the estimated values onto a kiviat surface. The monitoring process normalizes the kiviat surface to a unit circle of the estimated values, and generates an annular residual between the normalized monitored values and normalized estimated values. The monitoring process compares the annular residual to a threshold for detecting the resonant vibration amplification. Where the annular residual satisfies the threshold, resonance detection method 200 detects the resonant vibration amplification.

In one embodiment, resonance detection method 200 detects resonant vibration amplification (discussed above at block 225 based on detecting an anomaly in a series of residuals between the vibration values and the estimated values for one of the resonance frequencies. In one embodiment, resonance detection method 200 generates a series of residuals between monitored values of the monitored vibrations and the estimated values for one or more of the resonance frequencies. And, resonance detection method 200 detects an anomaly in the series of residuals with a sequential probability ratio test. Where the anomaly is detected, resonance detection method 200 detects the resonant vibration amplification.

In one embodiment, the reference asset provides a reference for expected resonance behavior of a target asset. Because in-situ installations of assets may be unique, an asset may serve as its own reference, providing a reference for resonance behavior in a known state of degradation in the asset. Thus, in one embodiment, the reference asset and the target asset are the same asset. Also, the reference asset may provide a reference for expected resonance behavior of an entire class or type of assets having a similar configuration (up to and including a same configuration). Thus, in one embodiment, the reference asset and the target asset are of a similar configuration.

In one embodiment, the machine learning model (discussed above at block 220) includes a multivariate non-linear, non-parametric regression algorithm. For example, the machine learning model may implement a multivariate state estimation technique (MSET).

In one embodiment, resonance detection method 200 further presents a graphical user interface that presents a visualization of the resonance activity using Kiviat surfaces and Kiviat tubes (a series of Kiviat surfaces). In one embodiment, resonance detection method generates a kiviat tube of observations of the monitored vibrations. And, resonance detection method 200 generates a graphical user interface that displays the kiviat tube. The electronic alert causes an indication that resonant vibration amplification is detected to be displayed in the graphical user interface.

### Discussion and Additional Embodiments

Historically, vibration and acoustic sensors have been used to detect problems in assets in many types of industries problems that result in higher vibration levels, which can be precursors to failure. Additionally, these vibration levels can be amplified by resonant frequencies. Vibration and resonance characterization is generally conducted with two types of sensors, accelerometers (vibration sensors) and acoustic sensors. These sensors are limited in their ability to be predictive of the condition and resonances of an asset due to high sampling rates, large noise ratios, and outdated analysis methods. In one embodiment, the resonance detection system discussed herein addresses these issues by reducing the dimensions of the vibration and acoustic data to a more manageable size, minimizing the noise ratio, characterizing the prominent frequencies of an asset, and monitoring the frequency signature for prolonged resonance amplification.

Monitoring PSD peaks of vibration signals for resonance vibration without the resonance detection methods herein is unsatisfactory due to the tradeoff between (a) sensitive, low thresholds for catching incipient degradation and (b) dull, high thresholds for avoiding false alarms and associated unnecessary shutdowns of productive assets. In one embodiment, the resonance detection system solves this threshold conundrum by introducing a multivariate model for monitoring the vibration signals. The multivariate modeling allows alerts to be based on deviation from expected behavior at particular frequencies, rather than hard thresholds that fail to account for overall load on the system. In one embodiment, the resonance detection system separates univariate vibration signals into multivariate vibration signals for frequency ranges of interest: for example, the resonant frequencies of the monitored system. In one embodiment, the resonance detection system compresses the high-frequency (kHz) vibration signals (that present major challenges for storage and analysis) into more sparsely sampled time series signals. Thus, in one embodiment, the resonance detection system allows for lossless dimension reduction of the signals while producing a multivariate dataset from one vibration sensor that can be consumed and monitored by an ML model.

In one embodiment, as an example overview of an initial training phase, the resonance detection system transforms a single univariate vibration or acoustic signal into a plurality of (such as 20) correlated time series signals that is predictive of a unique operational frequency signature of an asset and tracks the resonance amplification behavior. First, during a measurement stage, a sine sweep loading pattern that covers an entire range of the asset operation, is introduced to excite resonance dynamics that are detectable in the frequency domain (for example as discussed above for process block 210). A second stage is composed of several sub-stages whereby the sensor (accelerometer and/or acoustic) measurements are manipulated by a frequency-domain to time-domain to frequency-domain double transformation (for example as discussed above for process block 215). The double transformation reduces the dimension of the data without loss of prognostic information. In a final stage the output is input into an ML algorithm generating a model for subsequent monitoring of new measurements. The ML monitoring informs condition-based decisions about the state and resonance behavior of a mechanical, electromechanical, or thermal-hydraulic system monitored by the sensors.

When utilizing ML to monitor an asset it may be beneficial for the training data to encompass the entire range of the system operation. An ML model trained with less than a full range of system operation may generate alerts when the system is operated outside of the training range of system operation. For example, a model for monitoring a car that is trained from data containing only surface street driving measurements will generate alarms if the car were to begin highway driving, or pushed to maximum performance levels, for example in a drag race or rally race. Therefore, in one embodiment, the entire operational range of an asset is incited during the initial stage of measurements to guarantee sufficient training data to generate a reliable model.

Vibration/acoustic measurements are subject to stochastic measurement noise that mask the true vibration activity of an asset. In one embodiment, the resonance detection system mitigates noise by transitioning the operational vibration classification of the asset into the frequency domain. In one embodiment, the resonance detection system can readily identify resonance signatures in the frequency domain, thereby bypassing noise that may have been overshadowing the representative frequencies of the system in the time domain.

In complex physical systems, the structure of the system and its constituent components have unique resonant frequencies that can amplify vibration and thereby increase the amplitude of the inertial forces the system undergoes. Such resonant vibration amplification can lead to false alarms and/or rapid degradation of an asset. The additional force of resonant vibration amplification can lead to diminished performance and an increase in the rate of degradation. For example, computer systems exhibit internal vibrational resonances inside hard disk drive (HDD) chassis. If the rotations per minute (RPM) of a fan intersects a structural resonance of the HDD, there is significant destructive amplification of vibrations that cause I/O misses on the HDD, or even cause the HDD to fail. Further, with age, ball bearings of fans lose roundness, lubrication dries out, and shaft axes gain eccentricity, each of which causes fan RPMs to drop over time due to increasing rotational friction. Thus, even when fan vibrations do not cause resonant vibrations at manufacturing time of the computer system, fan RPMs may drop down into structural resonances of the computer system causing an increasing rate of I/O misses and outright system failure. Analogous problems due to resonant vibration amplification can occur in all types of mechanical, electromechanical, or thermal-hydraulic systems.

In one embodiment, the resonance detection system applies a sine sweep workload to an asset for the express purpose of characterization the current state of the structural resonances (caused by dynamic coupling) during operation. The sine sweep workload can be applied on a range of physical assets, including for example mechanical, hydraulic, electric, and computer systems. In one embodiment, the resonance detection system applies a frequency-to-time-domain double transformation in conjunction with the Sine Sweep workload to identify and process resonance frequencies of an asset to be amenable for monitoring. In one embodiment, the resonance detection system tracks resonance frequencies over time to avoid excitation resonant vibration as changes in operational frequency occur over time through nominal degradation. In one embodiment, the resonance detection system utilizes a Kiviat tube and/or MSET to monitor the resonance frequencies of an asset over time, for example, in real time, so as to mitigate degradation of the asset. And, in one embodiment, the resonance detection system triggers a warning that a resonance is breached to allow for remediation either through automation or human intervention.

While most systems are qualified to have good vibrational integrity at the time and environmental conditions (such as altitude) at which it was manufactured, as the systems degrade, the system components may start to drift into resonance response. When this occurs, the system will start failing at an increasing rate. These problems extended to all types of mechanical, electromechanical, or thermal-hydraulic systems. In one embodiment, the resonance detection system implements a passive and proactive technique for detecting structural resonances before mechanical damage is incurred. To do so, for example, the resonance detection system autonomously characterizes, identifies, and monitors resonance in the system, providing the opportunity to recognize and remediate the resonance vibration amplification before substantial system degradation occurs.

Resonance remediation design is predicated on two basic principles: avoidance or mitigation. Avoidance is designing a system to narrow the range of frequencies that can be excited by resonance to make it easier to avoid excitation through stiffening, for example by way of tuned springs or braces. Or, for example, the small lead mass routinely affixed to the rims of all automotive wheels when tires are changed and re-balanced. But, when the resonant frequency is excited in a stiffened system, the magnitude of amplification is exponentially larger in magnitude. Mitigation is designing a system to broaden the range of the frequencies that can be excited by resonance but dampen the effect of resonance through elastomeric isolation, for example by applying high tensile strength (ductile) polymers, foams, or rubber gaskets. In one embodiment, the resonance detection system provides an alert that remediation should be performed in response to resonance amplifying vibration to excessive levels. In one embodiment, the alert includes a suggestion or instruction prescribing a specific remediation service, such as replacing worn stiffening springs or damping gaskets. This algorithm gives the user a clear indication when intervention and remediation are required.

Additionally, some systems allow for automated remediation by adjustment to operating speeds of the system or system components to avoid exciting the resonance. For example, RPMs of fans in a server may be programmatically adjusted to avoid a resonant frequency of the HDD chassis. Or, for example, rotational speed of a manufacturing machine may be adjusted to avoid a resonant frequency of a building in which the machine is housed. In one embodiment, the resonance detection system triggers initiation of automated remediation in response to resonance amplifying vibration to excessive levels. In one embodiment, the resonance detection system controls the assets to avoid exciting the resonance. In one embodiment, this automated remediation is short term, and continues until further repairs addressing the root cause can be conducted. In one embodiment, the automated remediation includes an automatic reduction or increase in operating speed for an asset or asset component.

In one embodiment, implementing the resonance detection system requires no hardware upgrades anywhere in the data center assets or the sensor-monitored assets, making this invention immediately backward compatible with existing data centers and sensor-monitored customer systems.

### —Sine Sweep—

In one embodiment, an asset is operated in a test pattern to provide a reference for expected resonance response of the asset, for example as discussed above at process block 210. Resonance detection is initiated with vibration or acoustic measurements of the test pattern. In one embodiment, the test pattern is a workload on the asset that is varied over an operational range of the asset. In one embodiment, to identify the resonance frequencies, an asset is run through a sine sweep workload that spans an entire frequency spectrum of the asset. In one embodiment, the test pattern (e.g., the sine sweep workload) is synthetically generated to span the frequency spectrum of asset vibration during operation. In one embodiment, resonance detection system synthesizes the test pattern. In one embodiment, the test pattern is input to asset by adjusting the input power levels of the asset according to the test pattern. In one embodiment, resonance detection system controls the asset (for example by throttling the input power level), causing the asset to operate in accordance with the test pattern.

FIG. 3 illustrates a line chart 300 that plots an example sine sweep workload 305 against a time axis 310 and an intensity or amplitude axis 315. In this example, intensity of operation of an asset is varied sinusoidally from full reverse operation of the asset (indicated by −1 on intensity axis 315), and full forward operation of the asset (indicated by 1 on intensity axis 315). Put simply, the workload or duty cycle of the asset is moved up and down through a range of variable speed.

In this example, sine sweep workload 305 is linearly changing in periodicity over the sweep. In particular, sine sweep workload is linearly increasing in periodicity as the sweep progresses. In other words, the workload is increased and decreased more and more rapidly over the course of the sweep. In another example, the sine sweep workload may linearly decrease in periodicity over the course of the sweep. Other modes of increase or decrease in periodicity of the sine sweep may also be acceptable. In another example, a sine sweep workload that ranges from full stop (indicated by 0 on intensity axis 315) to full forward operation may also be appropriate, for example where the asset does not have reverse operation.

In one embodiment, use of the sine sweep workload allows resonant frequency detection to be performed for an asset in situ, in the field. And, in one embodiment, use of the sine sweep workload does away with using external stimulus of vibrations, for example from a vibrating probe or shake table. Instead, in one embodiment, the duty cycle of the asset itself acts as the vibration source. In this way, deployed assets may be analyzed for resonant frequencies in the field.

In one embodiment, resonance detection system uses the sine sweep (or other test pattern) to excite the resonance frequencies of the asset. In one embodiment, resonance detection system detects excitation in the resonance frequencies by conducting a Cross Power Spectral Density (CPSD) analysis of the test pattern and the vibrational response of the asset. In one embodiment, the CPSD is determined for moving windows of vibration measurements. The moving window advances by increments of time to cover progressively later ranges of vibration measurements. The CPSD for each window of the raw vibration measurements produces a set of time series corresponding to individual frequencies in the spectrum. In one embodiment, the individual frequencies are at the finest resolution available from a spectrum analyzer, referred to herein as “fine” frequencies. The CPSD is a specific type of bivariate fast Fourier transform (FFT). Using the CPSD, the result of a convolution of two unique signals are converted into the frequency domain to amplify the frequency content the signals have in common. In this example instance the commonality of the frequencies between the vibration measurements and the Sine Sweep (or other test pattern) are the resonance frequencies of the asset. In other words, the resonance frequencies of the asset are emphasized in the CPSD.

### —Frequency Binning and Resonant Frequency Time Series Generation—

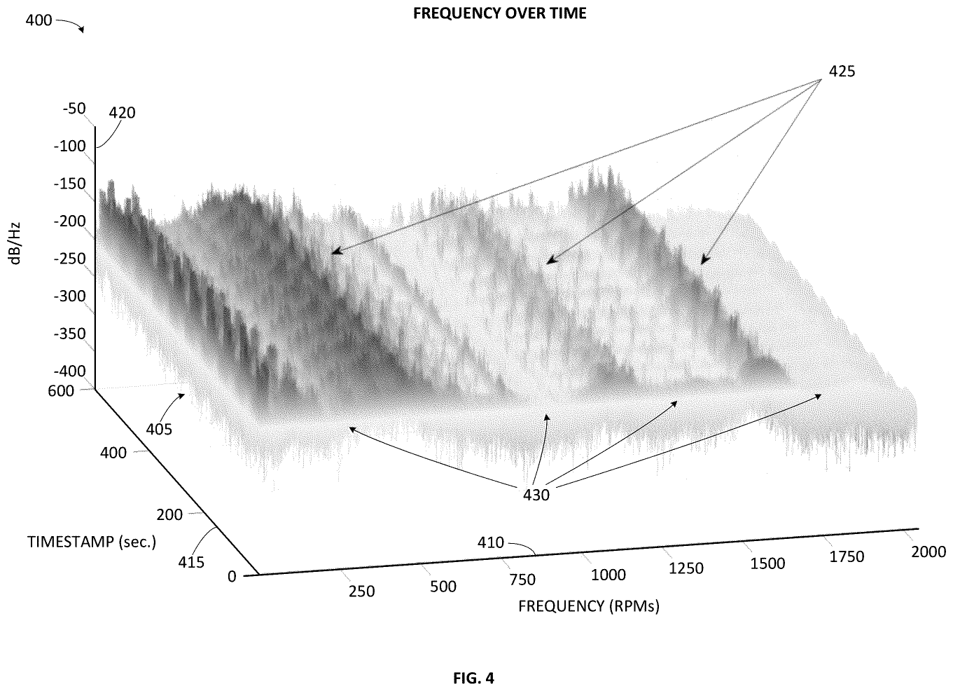

FIG. 4 illustrates a three-dimensional surface chart 400 of vibration amplitudes 405 for operational frequencies of an example asset. The vibration amplitudes 405 are plotted against a frequency axis 410, a timestamp axis 415, and an amplitude axis 420. Frequency axis 410 is measured in rotations per minute. Timestamp axis 415 is measured in seconds. Amplitude axis is measured in Decibels per Hertz. Vibration amplitudes 405 is an aggregate of time series signals for each frequency in the measurement spectrum (between 0 and 2000 RPM). The frequencies with increased peak amplitudes 425 correspond to resonance frequencies of the example asset. Thus, vibration amplitudes 405 displays the times series of the resonance frequencies of the example asset where increased peak amplitudes 425 are present.

The resonance frequencies are inherently problematic because if the asset or any one of its constituent parts operates at one of the resonance frequencies, the dynamic load and vibrational load on the asset are increased exponentially. The increase in load can cause decreased performance or increased degradation thereby leading to faster failure and increased operational shutdowns. For example, a fan for cooling a server that operates with RPM at or near a resonance frequency of the server as a whole causes the magnitude of vibration at the frequency of the RPM to increase dramatically. The increase in vibration caused by the resonance led to decreased HHD writing capacity and compute performance. In one embodiment, the resonance detection system is configured as a monitoring system that acts to trigger a control system of the asset operations so as to avoid the operational resonance frequencies, and thereby automatically mitigate the resonance phenomenon.

While the resonance frequencies are distinctly excited they lie in narrow bands of the entire sample spectrum, as is visible in the frequencies with increased peak amplitudes 425. In one embodiment, narrow bands of frequencies are grouped, or “binned” to isolate the resonance signature. The binned frequencies then undergo a process for reducing noise within each group and ranking by amplitude in the frequency domain. When a wide frequency spectrum is sampled, there will be unexcited frequencies that are essentially noise. For example, unexcited frequencies appear in the spectrum (from 0-2000 RPMs or approximately 0-35 Hz) of vibration amplitudes 405, for example at ranges of frequencies with low peak amplitudes 430.

In one embodiment, to identify the frequencies that are more representative of resonance activity, the resonance detection system may perform a binning process. The frequency spectrum is first split into several frequency bins. Subsequently, a technique to generate a time series signal that is a highly correlated average of the frequencies in the bin is applied. In one embodiment, to generate the highly correlated average, the fine frequencies included in the bin are observed (that is, the value is determined) at a repeated interval of time. A subset of the fine frequencies that are most highly correlated is identified. And, the average value of the subset of highly correlated fine frequencies of the bin at an observation are used as the value for the observation in the time series for the frequency bin. The highly correlated averaging technique is discussed in further detail below. Advantageously, this not only reduces the data size from a bin of many fine frequencies to one time series, but it also gets rid of noisy behavior in general by disregarding fine frequencies that do not exhibit correlated behavior. To summarize, in one embodiment, the binning process narrows the broad frequency spectrum and isolates the germane frequencies by “binning” the frequencies across linearly spaced ranges. And, the binning process then finds the most representative time series in the narrow band frequency bins by averaging the most highly correlated signals in the bin.

In one embodiment, a first step of the binning process is to decide the number of frequency bins to use for subdividing the spectrum. The total number of bins should be small enough to reduce the size of the spectrum data. In addition, the range of frequencies in each bin needs to be large enough to have a statistically significant sample guaranteeing the average time series is comprised of more than a couple of frequencies. Generally, through empirical findings, dividing the wide band spectrum into 100 coarse bins works for most applications. Accordingly, in one embodiment, the resonance detection system accesses a pre-set number B of bins (e.g., B=100 bins), and subdivides the spectrum of fine frequencies into B bins.

Many of the bins, even after grouping, are just random noise, such as bins in ranges of frequencies with low peak amplitudes 430. Conversely the most correlated bins (i.e., those bins that include the most correlated fine frequencies) prominently respond to the Sine Sweep workload source, such as bins in ranges of frequencies with increased peak amplitudes 425. For some bins, a simple average over the frequencies in the bin will filter out the random noise yielding a signal with diminutive noise ratio because the random noise signals negate each other. Unfortunately, most bins are a mixture of noisy measurements, which are of frequencies that are unresponsive to the load activity, and dynamic content (that is, measurements of frequencies that are responsive to the load activity). Thus, the simple average can result in a signal with less range. Instead, a subset of signals inside the frequency bin with the best inter-correlations are averaged, further filtering out the noise, yielding a lower noise ratio signal and revealing the dynamic pattern of the workload.

To accomplish the correlated averaging the signals in each bin are subjected to a correlation matrix assessment whereby the correlation coefficients are summed over the signals and sorted from lowest to highest. In one embodiment, then, the signals corresponding to the top percentile are selected and averaged, yielding a single time series signal for that frequency bin. Percentile is used instead of correlation coefficient as the threshold so this approach is adaptive and can be applied to any frequency bin with any distribution of noise ratio.

After the binning step, a sorting process is conducted to further reduce the problem size by discarding the frequency bins that are least representative of the resonance frequencies of the system. The signals with the strongest frequency components in the in the spectrogram are chosen while the remainder are ignored. To determine the strongest frequency components the resultant 100 time series from the binning step are transformed into the frequency domain again. The bins are sorted by the magnitude of the PSD. After the sorting has occurred the number of bins that are discarded is dependent on the sensitivity requirements of the system, 20% of the number of discrete frequency bins is recommended for selecting the top signals based on the height of the peak in the frequency domain. As with the 100 bins the top 20% have been determined, through empirical use, to be the most representative of the frequency behavior of most assets.

The sorting step is greatly enhanced by the loading (test) pattern. Without the loading pattern, the ranking process is much more ambiguous because of several factors that can influence the ranking. For example, a trend can be introduced into the time domain caused by an exogenous or stochastic process that does not directly influence the system. If this occurs, the affected bin, when converted into the frequency domain, with a limited sample, will have a large PSD peak near 0 Hz. The reason for the large peaks is that the low frequency will generate a large Fourier coefficient. The magnitude of the low frequency can overshadow the remaining PSD peaks resulting in a high-ranking bin that is not representative of the resonance signature of the system. Another source of ambiguity is the variation in excited frequencies which can be dependent on the operational state during the instance of measurements. This variation can also result in outlier frequencies with a large PSD peak resulting in inconsistent sorting.

When the loading pattern (such as sine sweep workload) is introduced into the training measurements, the precision of the sorting increases. For example, the loading pattern introduces consistency into the measurements and the operation of the system, which reduces measurement noise. Moreover, as aforementioned, the workload should cover the entire range of normal operation for the asset. These properties lead to consistent frequency identification for a system unless the condition of the system has degraded.

### —Example Resonance Detection Framework—

FIG. 5 illustrates one embodiment of a resonance detection framework 500 for data collection, pre-processing, and monitoring associated with swept sine duty cycle and CPSD analysis for ML-based identification and characterization of resonance phenomena. Resonance detection framework 500 is laid out as one example process by which detection that vibration of an asset is amplified or is excessive due to resonance of the asset. Resonance detection framework 500 includes a digital signal processing (DSP) phase 505, followed by a frequency analysis phase 510, and then a monitoring phase 515.

In one embodiment, resonance detection framework 500 initiates at start block 520, and proceeds to block 522. At block 522, resonance detection framework 500 initiates a test pattern, or workflow for testing a reference asset. For example, resonance detection framework 500 initiates a sine sweep operational workload. The test pattern causes the workload on the asset to sweep sinusoidally across a range of operation of the asset. At block 524, resonance detection framework 500 initiates a window index tₘ for to an initial window position t₀. Resonance detection framework 500 then proceeds to DSP phase 505.

DSP phase 505 includes a loop for capturing the occurrence of structural resonances in an asset over the course of application of the test workload. The loop repeatedly captures the CPSD combination of the current frequency being driven by the test workload and the sensed vibrations of the asset during a window of time. For example, a CPSD is taken between the frequency of the workload and the sensed vibrations for each window index tₘ between the initial window position to and a final window position t_{end}. At decision block 526, the DSP phase 505 determines whether the current value for window index tₘ is below the final window position t_{end}. In this way, resonance detection framework 500 determines whether CPSDs of vibration measurements and the corresponding test workload have been performed for all positions of the moving window. If the current value for window index tₘ is not below the final window position t_{end} (tₘ<t_{end}:FALSE), DSP phase 505 completes and resonance detection framework 500 proceeds to frequency analysis phase 510. If the current value for window index tₘ is below the final window position t_{end} (tₘ<t_{end}:TRUE), DSP phase 505 proceeds to block 528 to take a further window of vibration measurements.

At block 528, DSP phase 505 takes vibration measurements of a reference asset with one or more sensors. In one embodiment, the system receives or otherwise accesses vibration measurements over the current window of time from sensors configured to detect vibration in the reference asset. The vibration measurements may be provided in a stream. The vibrations in the asset are produced by operating the reference asset in accordance with the range of the test pattern that corresponds to the current window of time. The vibration measurements are stored or recorded for subsequent processing.

At block 530, DSP phase 505 conducts a CPSD of the test pattern and the vibration measurements over the current window, and determines a power spectral density (PSD) or frequency spectrum of the resulting CPSD. In one embodiment, the test pattern is the sine sweep test workload. At block 532, the current window position tₘ is incremented to a next window position tₘ₊₁, and processing returns to block 526 to determine whether to conduct a further iteration through the loop, or proceed to the frequency analysis phase.

Frequency analysis phase 510 operates to determine a set of resonant frequencies. The set of frequencies identified are frequencies at which there is a greatest amount of resonant amplification of vibrations caused in the reference asset by operating the reference asset within the range covered by the test pattern. At block 534, the frequency analysis phase 510 accesses the output of the frequency spectrum of the vibration measurements as they change over time. In other words, the frequency analysis phase 510 accesses the cumulative frequency spectrum (PSD) for the moving windows. For example, the frequency analysis phase concatenates a series of the frequency spectra (PSDs) from initial window position t₀ and a final window position t_{end} to produce the frequency spectrum of the vibration measurements over time. FIG. 4 above shows one example of a frequency spectrum of vibration measurements over time.

At block 536, the frequency analysis phase 510 divides the frequency spectrum into a number N_{bins} of coarse frequency bins Xᵢ^{N}. For example, the frequency analysis phase 510 identifies the bottom and top vibration frequencies of the frequency spectrum, and partitions the range of frequencies between the top and bottom frequencies into the number N_{bins} of bins to produce the coarse frequency bins Xᵢ^{N}.

Block 538 initiates a loop for correlated averaging of the signals within the bins. At block 538, frequency analysis phase 510 initializes a loop index i to a value of 1, indicating the first bin of the N_{bins} bins. At decision block 540, frequency analysis phase 510 determines whether the current value of the loop index i remains within the number N_{bins} of bins. Where the loop index i is less than or equal to the number N_{bins} of bins (i<N_{bins}:TRUE), frequency analysis phase 510 proceeds to conduct correlated averaging of the current bin at block 542. Where the loop index i is greater than to the number N_{bins} of bins (i≤N_{bins}:FALSE), frequency analysis phase 510 has conducted correlated averaging on the N_{bins} bins and terminates the loop.

At block 542, frequency analysis phase 510 conducts correlated averaging on the current bin Xᵢ. The fine frequencies in the bin Xᵢ that have greatest cross-correlation coefficients with each other are identified and selected for inclusion in the correlated average, while the fine frequencies in the bin Xᵢ that have lesser cross-correlation coefficients are identified and disregarded (not included) in the correlated average. The average of the fine frequencies identified as having greatest cross-correlation coefficients to are then averaged on an observation-by-observation basis to produce a correlated average of the fine frequencies of the bin Xᵢ. Frequency analysis phase 510 then proceeds to increment the loop index i at block 544, and return to decision block 540. At decision block 540, frequency analysis phase 510 determines whether or not all bins have had a correlated average of their signals created, or whether further iterations through the loop for correlated averaging of individual bins are to be performed.

At block 546, frequency analysis phase 510 produces the output of the loop for correlated averaging. In one embodiment, the output of the loop is N_{bins} time series Yⱼ^{N}, one time series of correlated average values from each of the N_{bins} frequency bins. In one embodiment, the N_{bins} time series share a series of observation times in common, in other words, the observations of the N_{bins} time series are a sequence of contemporaneous observations of the N_{bins}.

Decision block 548 initiates a loop for determining the power spectral density (PSD) of the N_{bins} time series. In advance of decision block 548, a loop index j is initiated to a value of 1, indicating the first time series of the N_{bins} time series. At decision block 548, frequency analysis phase 510 determines whether the current value of the loop index j remains within the number N_{bins} of time series. Where the loop index j is less than or equal to the number N_{bins} of time series (j≤N_{bins}:TRUE), frequency analysis phase 510 proceeds to conduct a fast Fourier transform (FFT) and calculate the PSD of the jth time series Yⱼ at block 550. Frequency analysis phase 510 then proceeds to increment the loop index j at block 552, and return to decision block 548. Where the loop index jis greater than to the number N_{bins} of bins (j<N_{bins}:FALSE), frequency analysis phase 510 has generated a PSD for the N_{bins} bins and terminates the loop.

At block 554, the N_{bins} power spectral densities generated for the N_{bins} time series Yⱼ^{N} are sorted by respective magnitude of PSD amplitude. Frequency analysis phase 510 determines magnitude of amplitude for the PSDs of the N_{bins} time series Yⱼ^{N}, for example by determining a square root of a sum of the squares for the components of the PSD. And, frequency analysis phase 510 then sorts the N_{bins} time series Yⱼ^{N} in order (ascending or descending) of their respective magnitude. At block 556, a portion of the time series Yⱼ^{N} that have highest (greatest) magnitude of PSD amplitude are selected. For example, the top 20% of time series Yⱼ^{N} by magnitude of PSD amplitude are chosen. These top time series are time series for frequency bins in which the asset is most susceptible to resonant amplification of vibration. In other words, the time series that are selected represent the frequencies at which the asset resonates most strongly. These selected time series are thus time series for the resonant frequencies of the asset. This concludes the frequency analysis phase 510, and resonance detection framework 500 proceeds to monitoring phase 515.

Monitoring phase 515 includes ML model training and resonant frequency monitoring associated with detection of resonant vibration amplification in the asset based on the time series for the resonant frequencies of the asset. At block 558, monitoring phase 515 trains a machine learning model based on the resonant frequencies. The machine learning model is multivariate, with an input variable and output estimate corresponding to each of the resonant frequencies.

In one embodiment, the machine learning model is a multivariate state estimation technique (MSET) model. The machine learning model is trained using the time series selected to represent resonant frequencies. The machine learning model is trained to estimate levels of vibration at these frequencies that are consistent with vibration during undegraded operation of the reference asset across the range of operation of the asset. Substantial deviation from these estimates indicates the presence of resonant vibration amplification.

Once the ML model is trained, at block 560 monitoring phase 515 monitors incoming time series data with the MSET model and an anomaly detection test. The incoming time series data represents vibration of a target asset at the resonance frequencies. Monitoring phase 515 generates estimates of what the incoming time series data would be for the reference asset, provided that no unexpected resonant vibration amplification is occurring. Monitoring phase 515 then compares the actual values are compared with the model-generated estimates using an anomaly detection test. The anomaly detection test may be a sequential probability ratio test (SPRT)-based or Kiviat-tube-based comparison of the actual and estimated values. The anomaly detection test determines whether the incoming time series data deviates from the model-generated estimates of the time series data in an aberrant way, thereby detecting an anomaly. Detection of an anomaly indicates that resonant vibration amplification is occurring in the target asset.

At decision block 562, monitoring phase 515 determines whether or not excessive resonance is occurring in the target asset based on the results of the anomaly detection test. Where an anomaly is detected, excessive resonant vibration amplification is occurring in the target asset, and monitoring phase proceeds to actuate an alert at block 564. Otherwise, where no anomaly is detected, resonant vibration amplification, if any, is not excessive, and monitoring of the incoming time series data continues at block 560.

At block 564, monitoring phase 515 generates an electronic alert that resonant vibration amplification is occurring in the target asset. For example, the monitoring phase 515 composes an electronic message that indicates that the resonant vibration amplification is occurring in the target asset. The electronic message may indicate a time or observation during which the amplification is occurring. The electronic message may indicate a frequency for which the amplification is occurring. Monitoring phase 515 may transmit the electronic message to cause display of the message in a GUI. Monitoring phase 515 may transmit the electronic message to the workload of the target asset to be adjusted in a way that ameliorates the resonant vibration amplification, for example by adjusting operating speeds of the asset or its components away from stimulating the frequency for which the amplification is occurring.

### —Example GUI for Resonance Detection System—

Once the resonance frequencies are selected they can be monitored with MSET-SPRT or MSET-Kiviat-tube. In one embodiment, the resonance detection system performs a process of monitoring based on MSET estimation and Kiviat-tube anomaly detection. In one embodiment, to monitor a state of the asset the time series measurements for each resonance frequency are normalized, converted into the spherical coordinate system, and then projected onto a surface. This surface is then compared to a surface generated from time series readings of a golden system (GS). In one embodiment, the time series readings of the GS are generated by an MSET (or other multivariate machine learning model) that has been trained to produce time series readings consistent with a nominal resonance state of the reference asset. In one example, the golden system is the nominal, healthy (e.g., undegraded) resonance state of a mechanical, electrical, or hydrodynamic asset. The GS surface is developed by identifying the structural resonances with the aforementioned resonance detection framework 500, and utilizing the healthy system time series to train an MSET model. The MSET model is then utilized to generate golden system estimates of the healthy reference asset for comparison with new incoming measurements of a target asset (also referred to as a unit under test (UUT)). These may be presented as a time series of Kiviat surfaces, or Kiviat tube.

In one embodiment, the UUT measurements undergo a similar process to those used to present the GS measurements as a Kiviat tube. In particular, the incoming resonance frequency measurements are also normalized, converted to spherical coordinates, and projected onto a surface. However, there is no need to identify new resonance frequencies as the resonance frequencies for the target asset (UUT) correspond with the frequencies determined from the reference asset, and used in the GS. The measurements of the GS and UUT are repeated and checked at evenly-spaced intervals or observations. If the surface representing the UUT deviates from the GS surface an alarm is triggered.

In one embodiment, an informative Graphical User Interface (GUI) may be generated to present the results of the monitoring in a Kiviat tube. FIG. 6A illustrates an example of a Kiviat tube GUI 600 representing a first point in time when the target system is not undergoing vibration resonance. Kiviat tube GUI 600 shows a Kiviat tube of the reference system (GS) (referred to herein as a “reference tube”) 605 and a Kiviat tube of the target system (UUT) (referred to herein as a “target tube”) 610. Kiviat tube GUI 600 may show the results of monitoring of pertinent resonance frequencies at given points in time for each frequency, as shown in FIGS. 6A-6C. In one embodiment, results at a given point in time for the various resonance frequencies may be viewed simultaneously.

Kiviat tube GUI 600 displays a current state for an asset (e.g., rotating machinery) at the first point in time in target system Kiviat plot 615. Target system Kiviat plot 615 includes axes for 20 resonant frequencies of the reference asset. In this example, the resonant frequencies identified for the reference asset (e.g., by frequency analysis phase 510) are 10, 60, 120, 180, 240, 300, 360, 420, 490, 550, 610, 670, 730, 790, 850, 910, 980, 1040, 1100, and 1160 RPMs. Target system Kiviat plot 615 shows a surveillance Kiviat surface 620 representing vibration levels of the target asset that are sensed at the resonance frequencies at the first point in time. Surveillance Kiviat surface 620 is thus a surface plot of one observation of the target asset at the resonance frequencies. In this way, surveillance Kiviat surface represents vibration surveillance data from the target asset.

Kiviat tube GUI 600 displays an expected state of the asset under nominal operation at the first point in time in reference system Kiviat plot 625. Reference system Kiviat plot 615 also includes the axes for the 20 resonant frequencies of the reference asset. Reference system Kiviat plot 625 shows a reference Kiviat surface 630 representing expected vibration levels for the target asset that are generated at the resonance frequencies for the first point in time. These expected vibration levels at the resonance frequencies may be generated by the MSET model based on the observation of the target asset. Reference kiviat surface 630 is thus a surface plot of estimates of what the vibration levels are expected to be at the first point in time, provided that the target asset is behaving consistently with nominal operation.

The kiviat surfaces for multiple points in time are compiled sequentially in time to form Kiviat tubes, as shown by the 3D plots of reference tube 605 and target tube 610. In particular, reference system Kiviat plots for a series of points in time are compiled in ascending order of time to form reference tube 605. And, target system Kiviat plots for the series of points in time are compiled in ascending order of time to form target tube 610.

Kiviat tube GUI 600 may highlight an individual surface by coloring, shading, or otherwise visually differentiating the individual Kiviat surface from the other Kiviat surfaces in the Kiviat tubes. Reference Kiviat surface 630 is shown highlighted in reference tube 605 among other reference Kiviat surfaces included in reference tube 605, thereby indicating the position in time of reference Kiviat surface 630 with respect to other reference surfaces in reference tube 605. Surveillance Kiviat surface 620 also appears highlighted in target tube 610 among other surveillance Kiviat surfaces included in target tube 610, thereby indicating the position in time of surveillance Kiviat surface 620 with respect to the other surveillance Kiviat surfaces in target tube 610.

In one embodiment, reference tube 605 and target tube 610 are of the same length, that is, have a same number of observations or points in time. And, the observations of reference tube 605 and target tube 610 correspond with respect to position in time. For example, surveillance Kiviat surface 620 and reference Kiviat surface 630 occupy corresponding observations in target tube 610 and reference tube 605, respectively, and represent actual and estimated values for the resonant frequencies at a same point in time. In this example, the first point in time is at timestamp t=30 seconds.

Kiviat tube GUI 600 displays a current relative difference between the two surfaces (reference Kiviat surface 630 and surveillance Kiviat surface 620) in change in resonance detector (“detector”) 635. In detector 635, reference Kiviat surface 630 is normalized so that reference Kiviat surface 630 appears as a unit circle 640. In detector 635, surveillance Kiviat surface 620 is normalized by the same ratios on each axis that were also used to normalize reference Kiviat surface 630 to produce a normalized surveillance Kiviat surface (“normalized surface”) 645.

The normalization process may be referred to herein as normalizing to a unit circle of the reference surface. In detector 635, both the surveillance Kiviat surface 620 and reference Kiviat surface 630 are shown normalized to a unit circle 640 of the reference kiviat surface 630. In one embodiment, to normalize to the unit circle, the amplitude values of the N resonance frequencies for the reference Kiviat surface 630 are multiplied by a set of N coefficients to cause the border of the reference surface 630 to be a unit circle 640. Here, the term “unit circle” is used for convenience, and includes a unit N-sided polygon. In the set of coefficients, there is one coefficient assigned to each of the N resonance frequencies. The amplitude values of the resonance frequencies for the surveillance Kiviat surface 620 are also multiplied by the N coefficients assigned to the resonance frequencies, resulting in normalized surface 645. The surveillance Kiviat surface is thus normalized to the unit circle of the reference Kiviat surface.

At the point in time displayed FIG. 6A, the target asset is operating without the occurrence of any excessive resonance amplification. That undue resonance amplification is absent is validated by both (1) the commensurate kiviat tubes 605, 610, as well as (2) the marginal difference between the surface areas of the two kiviat surfaces after normalization, as shown in detector 635.

FIG. 6B illustrates the example of Kiviat tube GUI 600 representing a second point in time when the target system is undergoing vibration resonance. At this later point in time, either an internal component of the target asset or some exogenous force on the target asset is operating at one of the resonance frequencies, in particular the resonance frequency of 790 RPMs. The resonance causes an amplification in vibration at the 790 RPM resonance frequency.

Kiviat tube GUI 600 displays a current state for an asset (e.g., rotating machinery) at the second point in time in target system Kiviat plot 615. In this example, the second point in time is at timestamp t=200 seconds. Target system Kiviat plot 615 shows a second surveillance Kiviat surface 650 representing vibration levels of the target asset that are sensed at the resonance frequencies at the second point in time. Kiviat tube GUI 600 displays an expected state of the asset under nominal operation at the second point in time in reference system Kiviat plot 625. Reference system Kiviat plot 625 shows a second reference Kiviat surface 655 representing expected vibration levels for the target asset that are generated by the MSET model at the resonance frequencies for the second point in time. The second reference Kiviat surface 655 is normalized to a unit circle 642 and displayed in resonance detector 635. The second surveillance kiviat surface 655 is normalized to the unit circle 642 to generate a second normalized surface 647. Second normalized surface 647 is displayed in resonance detector 635. Second reference Kiviat surface 655 and second surveillance Kiviat surface 650 are highlighted in reference tube 605 and target tube 610.

The amplification in vibration at the 790 RPM resonance frequency is indicated by increased size 657 of the target tube 610 during the resonance. The amplification in vibration at the 790 RPM resonance frequency is also indicated by the relative change between the two surfaces visible in detector 635, especially the large increased magnitude spike 660 of the value at 790 RPMs.

In one embodiment, the differences between the surfaces will trigger an electronic alarm or alert to initiate further investigation of the asset. The alarm may be presented visually in Kiviat tube GUI 600 by displaying an alert indicator 665 in response to the detection of resonance amplification of vibration. In one embodiment, alert indicator 665 may be configured as a shape with a color that attracts attention of a user, such as red. In one embodiment, alert indicator may remain displayed while resonance amplification is ongoing, and be removed once resonance amplification terminates.

In one embodiment, to accomplish the mitigation, detection of excessive vibration due to resonant amplification would trigger, for example, an investigation by a human and a subsequent response. Or, in one embodiment, to accomplish the mitigation, detection triggers an automated command to alter the frequency of the internal components of the asset. The change in frequency removes the resonant vibration amplification which is indicated by the decrease in the size of the kiviat tube 670, the reduced marginal difference between the two surface areas, and the disappearance of the spike 660 at the 790 RPMs.

In one embodiment, the electronic alert may trigger a change in workload of the target asset. The change is configured to cause the target asset to avoid stimulating the resonant frequency by changing the frequency of the internal operations of the component. The change may be an increase or decrease in power supplied to the target asset or components of the target asset to cause components that may be rotating at the resonant frequency to change the speed of their rotation. The components will continue to rotate, but at a speed other than the resonant frequency. For example, the electronic alert may prompt a control circuit that controls the power supply to the target asset to reduce the power provided. The target asset is thus automatically operated to correct for the resonant amplification of vibration. In this way, the resonance can be automatically mitigated. In one embodiment, automated mitigation may be a temporary measure until physical mitigation or avoidance measures may be installed or repaired. In one embodiment, automated mitigation is carried out on an ongoing basis in response to the detection of resonant amplification of vibrations.

### —Additional Example Method for Resonance Detection—

FIG. 7 illustrates an additional example method for resonance detection, Kiviat-based detection method 700. Kiviat-based detection method 700 illustrates one embodiment in which a Kiviat tube, rather than a multivariate SPRT test, is used to detect when resonant amplification of vibration is occurring. In one embodiment, Kiviat-based detection method 700 initiates at start block 705, for example in response the satisfaction of one or more conditions similar to those described above for initiating resonance detection method 200.

At block 710, Kiviat-based detection method 700 determines the resonant frequency bins for the reference asset (GS). In one embodiment, there are 20 resonant frequency bins Xᵢ²⁰ for the reference asset. In one embodiment, the resonant frequency bins Xᵢ²⁰ are selected as described above with reference to frequency analysis phase 510 of resonance detection framework 500.

At block 715, Kiviat-based detection method 700 trains a multivariate ML model (such as MSET) with the 20 resonant frequency bins Xᵢ²⁰. The ML model is trained to generate estimates that are consistent with nominal behavior of the reference asset.

At block 720, Kiviat-based detection method 700 initiates surveillance of a target asset (UUT) at the 20 resonant frequency bins Xᵢ²⁰. The surveillance continues over a time series of observations of the 20 resonant frequency bins Xᵢ²⁰. Kiviat-based detection method 700 sets a current timestamp tᵢ to be an initial timestamp t₀. The range for surveillance extends from initial timestamp t₀ to a final timestamp t_{final}. Multiple surveillance ranges may be surveilled in sequence, for example, in real-time streaming surveillance of a target asset.

At decision block 725, Kiviat-based detection method 700 checks to determine whether a final observation of the surveillance range (having final timestamp t_{final}) has not yet been analyzed for resonant amplification of vibration. If so (t₀<t_{final}:TRUE), Kiviat-based detection method 700 commences analysis of a current observation in the surveillance range (having current timestamp tᵢ) for resonant amplification of vibration at block 730.

At block 730, Kiviat-based detection method 700 initializes monitoring of an observation of the target asset at the resonant frequencies UUTᵢ²⁰. The monitoring uses time series sampled from the 20 resonant frequency bins Xᵢ²⁰ that were previously determined for the reference asset. Kiviat-based detection method 700 inputs the current observed values of the resonant frequencies UUTᵢ²⁰ to the trained MSET model to generate estimated values of nominal amplitude of vibration at the resonant frequencies.

At block 735, Kiviat-based detection method 700 generates a reference Kiviat surface (in other words, a Kiviat surface for the GS) using the estimated values. In one embodiment, Kiviat-based detection method 700 plots the estimated values for the resonant frequencies as points on respective axes for the resonant frequencies in a Kiviat chart. Then, Kiviat-based detection method 700 generates the reference Kiviat surface by connecting the points on adjacent axes with lines. In one embodiment, at block 740, Kiviat-based detection method 700 appends the reference Kiviat surface to a reference Kiviat tube along a time axis. The reference Kiviat surface is added to the reference Kiviat tube at current timestamp tᵢ.

At block 745, Kiviat-based detection method 700 generates a surveillance Kiviat surface (in other words, a Kiviat surface for the UUT) using the observed values. In one embodiment, Kiviat-based detection method 700 plots the observed values for the resonant frequencies as points on respective axes for the resonant frequencies in a Kiviat chart and connects the points on adjacent axes with lines to produce the surveillance Kiviat surface. In one embodiment, at block 750, Kiviat-based detection method 700 appends the surveillance Kiviat surface to a target Kiviat tube along a time axis. The surveillance Kiviat surface is added to the target Kiviat tube at current timestamp tᵢ.

At block 755, Kiviat-based detection method 700 normalizes the reference Kiviat surface and the surveillance Kiviat surface to a unit circle of the reference Kiviat surface. In one embodiment, for both the reference Kiviat surface and the surveillance Kiviat surface, the position of the point on each resonant frequency axis is scaled by a coefficient that causes the position to have a value of 1 for the reference kiviat surface.

At block 760, Kiviat-based detection method 700 determines an area of annular residuals between the normalized reference Kiviat surface (based on MSET estimates for resonant frequency values GSᵢ²⁰) and the normalized surveillance Kiviat surface (based on observed values UUTᵢ²⁰ for the resonant frequencies). In one embodiment, the area of the annular residual is the area bounded by a border or outline of the normalized, unit circle reference Kiviat surface and a border or outline of the normalized surveillance Kiviat surface. Where the borders intersect, the areas inside and outside the unit circle add cumulatively.

At decision block 765, Kiviat-based detection method 700 determines whether the area of annular residual remains below a threshold. The threshold distinguishes between the area indicating that excessive structural resonance is occurring, and the area indicating the structural resonance, if any, is nominal. In one embodiment, the threshold is specified as a fraction of the area of the normalized unit circle. For example, the threshold is in a range of 0.01% to 50% of the area of the normalized, unit circle reference Kiviat surface. The threshold may be chosen to effect a desired level of sensitivity to resonance. In one example, the threshold is set between 1% and 10%, such as 5%, of the area of the unit circle.

Where the area of the annular residual is not below the threshold area (area<threshold?:FALSE), Kiviat-based detection method 700 proceeds to block 770 to issue an alert that structural resonance is occurring. After issuing the alert, for example the electronic alert described elsewhere herein, Kiviat-based detection method 700 proceeds to block 775 to increment the current timestamp tᵢ by 1 (tᵢ=tᵢ+1). Where the area of the annular residual is below the threshold area (area<threshold?:TRUE), Kiviat-based detection method 700 bypasses generating an alert at block 770, and proceeds directly to incrementing the current timestamp tᵢ at block 775.

Kiviat-based detection method 700 then returns to decision block 725 to determine whether or not to proceed through another iteration of the loop through blocks 730-775 for the next observation (the observation at the incremented timestamp). Where the observation at the final timestamp has been analyzed, there are no observations remaining in the surveillance range (tᵢ<t_{final}?:FALSE), and Kiviat-based detection method 700 proceeds to END block 780 and completes.

### —Selected Advantages—

In one embodiment, the resonance detection systems and methods described herein offer improved (heightened) prognostic sensitivity for detecting subtle anomalies in univariate vibration or acoustic signal, but with ultra-low false-alarm probabilities (FAPs) and missed-alarm probabilities (MAPs). In short, the resonance detection systems and methods offer earlier and more accurate detection of resonant amplification of vibration. This allows the earliest opportunity to remediate the damaging and potentially dangerous amplification, and on one embodiment, enables automatic adjustment to the operation of the asset so as to avoid driving the asset (or components) at resonant frequencies.

In one embodiment, the software instructions for executing the resonance detection method are adaptable. For example, the software instructions may be deployed alongside other computations in one container, or deployed in a separate container. The software instructions may be deployed as a cloud service to take advantage of cloud scalability, or on local or cloud-edge servers to operate with reduced latency.

In one embodiment, the sampling of time series from frequency bins of a PSD/CPSD spectrum significantly reduces the data density over the raw vibrations recorded by the sensors. This enables resonant amplification of vibration to be detected using lower sampling rate, frequency-specific data in the sampled time series. Such detection would not have been possible using the raw vibration or acoustic data that has a high-sampling rate and covers broad spectrum of frequencies at least because the high-sampling rate renders the raw data unmanageably large. Thus, in one embodiment, the resonance detection method renders resonant amplification monitoring possible in live, real-time applications where such real-time detection of resonant vibration amplification was not previously possible.

### —Overview of Multivariate ML Anomaly Detection—

In general, multivariate ML modeling techniques used for ML anomaly detection predict or estimate what each signal should be or is expected to be based on the other signals in a database or collection of time series signals. The predicted signal may be referred to as the “estimate”. A multivariate ML anomaly detection model is used to make the predictions or estimates for individual variables based on the values provided for other variables. For example, for Signal 1 in a database of N signals, the multivariate ML anomaly detection model will compute an estimate for Signal 1 using signals 2 through N.

In one embodiment, the ML anomaly detection model may be a non-linear non-parametric (NLNP) regression algorithm used for multivariate anomaly detection. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, the ML anomaly detection model may be another form of algorithm used for multivariate anomaly detection, such as a neural network (NN), Support Vector Machine (SVM), or Linear Regression (LR).

The ML anomaly detection model is trained to produce estimates of what the values of variables should be based on training with time series readings (such as time series signals) that represent normal or correct operation of a monitored asset. The training process involves iteratively optimizing a configuration of the ML model until the ML model consistently predicts expected values for the training portion of the individual signal that match (within an acceptable tolerance) the actual values of the training portion of the individual signal. To train the ML anomaly detection model, the time series readings are used to adjust the ML anomaly detection model. A configuration of correlation patterns between the variables of the ML anomaly detection model is automatically adjusted based on values of the time series readings so as to cause the ML anomaly detection model to produce accurate estimates for each variable based on inputs to other variables. Sufficient accuracy of estimates to conclude determine the ML anomaly detection model to be sufficiently trained may be determined by residuals being minimized below a pre-configured training threshold. A residual is a difference between an actual value (such as a measured, observed, sampled, or resampled value) and an estimate, reference, or prediction of what the value is expected to be. At the completion of training, the ML anomaly detection model has learned correlation patterns between variables.

Following training, the ML anomaly detection model may be used to monitor time series readings. Subtracting an actual, measured value for each signal from a corresponding estimate gives the residuals or differences between the values of the signal and estimate. Where there is an anomaly in a signal, the measured signal value departs from the estimated signal value. This causes the residuals to increase, triggering an anomaly alarm. Thus, the residuals are used to detect such anomalies where one or more of the residuals indicates such a departure, for example by becoming consistently excessively large.

For example, the presence of an anomaly may be detected by a sequential probability ratio test (SPRT) analysis of the actual and estimated values for a signal. In one embodiment, the SPRT calculates a cumulative sum of the log-likelihood ratio for each successive residual between an actual value for a signal and an estimated value for the signal, and compares the cumulative sum against a threshold value indicating anomalous deviation. Where the threshold is crossed, an anomaly is detected, and an electronic alert indicating the anomaly may be generated.

Or, for example, the presence of an anomaly may be detected by a Kiviat-tube-based analysis of the actual and estimated values for the signals. In one embodiment, the Kiviat-tube-based analysis determines an annular residual between a Kiviat surface of the actual values normalized to a unit circle of the estimated values and a Kiviat surface of the estimated values normalized to the unit circle. The area of the annular residual is compared to a threshold area indicating anomalous deviation. Where the threshold is crossed, an anomaly is detected, and an electronic alert indicating the anomaly may be generated.

### —Electronic Alerts—

In one embodiment, an electronic alert is generated by composing and transmitting a computer-readable message. The computer readable message may include content describing the anomaly that triggered the alert, such as a time when the anomaly was detected, an indication of the signal value that caused the anomaly, an identification of a resonant frequency for which the anomaly occurred and a target asset for which alert is applicable. In one embodiment, an electronic alert may be generated and sent in response to a detection of an anomalous signal value. The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of an automated function in response to detection of an anomaly in a resonant frequency.

In one embodiment, the automated function is configured to adjust the physical state or activity of the asset or component of the asset that is associated with the cluster, such as by triggering a maintenance response for or reduction of power to (e.g., slowdown or shutdown) the asset or component of the asset. In one embodiment, the electronic alert may be presented in a user interface such as a graphical user interface (GUI) by extracting the content of the electronic alert by a REST API that has received the electronic alert. The GUI may present a message, notice, or other indication that the status of operation of a specific machine, asset component, or other signal source has entered (or left) an anomalous state of operation.

### —Cloud or Enterprise Embodiments—

In one embodiment, the present system (such as resonance detection system 100) is a computing/data processing system including a computing application or collection of distributed computing applications for access and use by other client computing devices that communicate with the present system over a network. In one embodiment, resonance detection system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, resonance detection system 100 is a centralized server-side application that provides at least the functions disclosed herein and that is accessed by many users by way of computing devices/terminals communicating with the computers of resonance detection system 100 (functioning as one or more servers) over a computer network. In one embodiment resonance detection system 100 may be implemented by a server or other computing device configured with hardware and software to implement the functions and features described herein.

In one embodiment, the components of resonance detection system 100 may be implemented as sets of one or more software modules executed by one or more computing devices specially configured for such execution. In one embodiment, the components of resonance detection system 100 are implemented on one or more hardware computing devices or hosts interconnected by a data network. For example, the components of resonance detection system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of resonance detection system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of resonance detection system 100 may (i) generate or compose an electronic message or signal to issue a command or request to another component, (ii) transmit the message or signal to other components of resonance detection system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by resonance detection system 100, for example through a web interface server. In one embodiment, the remote computing system may send requests to and receive responses from resonance detection system 100. In one example, access to the information or applications may be effected through use of a web browser on a personal computer or mobile device. In one example, communications exchanged with resonance detection system 100 may take the form of remote representational state transfer (REST) requests using JavaScript object notation (JSON) as the data interchange format for example, or simple object access protocol (SOAP) requests to and from XML servers. The REST or SOAP requests may include API calls to components of resonance detection system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

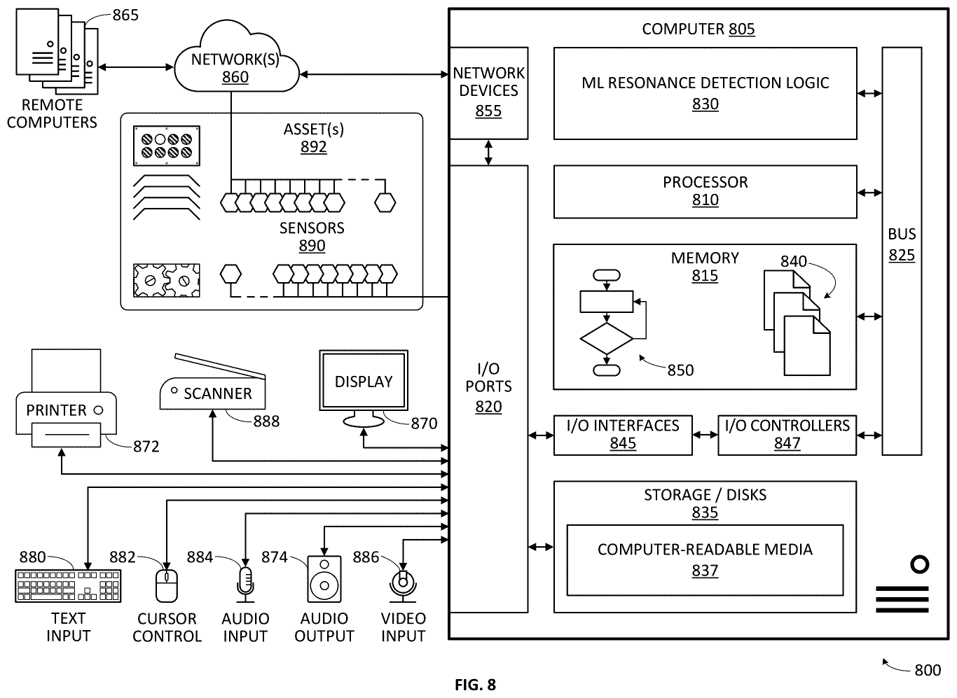

FIG. 8 illustrates an example computing system 800 that is configured and/or programmed as a special purpose computing device(s) with one or more of the example systems and methods described herein, and/or equivalents. The example computing device may be a computer 805 that includes at least one hardware processor 810, a memory 815, and input/output ports 820 operably connected by a bus 825. In one example, the computer 805 may include ML resonance detection logic 830 configured to facilitate ML-based identification and characterization of resonance phenomena in various engineering assets, similar to resonance detection logic/system 100 shown in and/or described with reference to FIGS. 1-7.

In different examples, the logic 830 may be implemented in hardware, one or more non-transitory computer-readable media 837 with stored instructions, firmware, and/or combinations thereof. While the logic 830 is illustrated as a hardware component attached to the bus 825, it is to be appreciated that in other embodiments, the logic 830 could be implemented in the processor 810, stored in memory 815, or stored in disk 835.

In one embodiment, logic 830 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate ML-based identification and characterization of resonance phenomena in various engineering assets. The means may also be implemented as stored computer executable instructions that are presented to computer 805 as data 840 that are temporarily stored in memory 815 and then executed by processor 810.

Logic 830 may also provide means (e.g., hardware, non-transitory computer-readable medium that stores executable instructions, firmware) for performing one or more of the disclosed functions and/or combinations of the functions.

Generally describing an example configuration of the computer 805, the processor 810 may be a variety of various processors including dual microprocessor and other multi-processor architectures. A memory 815 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 835 may be operably connected to the computer 805 via, for example, an input/output (I/O) interface (e.g., card, device) 845 and an input/output port 820 that are controlled by at least an input/output (I/O) controller 847. The disk 835 may be, for example, a magnetic disk drive, a solid-state drive, a floppy disk drive, a tape drive, a Zip drive, a flash memory card, a memory stick, and so on. Furthermore, the disk 835 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 815 can store a process 850 and/or a data 840, for example. The disk 835 and/or the memory 815 can store an operating system that controls and allocates resources of the computer 805.

The computer 805 may interact with, control, and/or be controlled by input/output (I/O) devices via the input/output (I/O) controller 847, the I/O interfaces 845, and the input/output ports 820. Input/output devices may include, for example, one or more network devices 855, displays 870, printers 872 (such as inkjet, laser, or 3D printers), audio output devices 874 (such as speakers or headphones), text input devices 880 (such as keyboards), cursor control devices 882 for pointing and selection inputs (such as mice, trackballs, touch screens, joysticks, pointing sticks, electronic styluses, electronic pen tablets), audio input devices 884 (such as microphones or external audio players), video input devices 886 (such as video and still cameras, or external video players), image scanners 888, video cards (not shown), disks 835, and so on. The input/output ports 820 may include, for example, serial ports, parallel ports, and USB ports.

The computer 805 can operate in a network environment and thus may be connected to the network devices 855 via the I/O interfaces 845, and/or the I/O ports 820. Through the network devices 855, the computer 805 may interact with a network 860. Through the network 860, the computer 805 may be logically connected to remote computers 865. Networks with which the computer 805 may interact include, but are not limited to, a local area network (LAN), a wide area network (WAN), and other networks.

In one embodiment, the computer 805 may be connected to sensors 890 through I/O ports 820 or networks 860 in order to receive information about physical states of monitored machines, devices, systems, facilities, or other apparatuses (collectively referred to as “assets” 892) and components thereof. In one embodiment, the sensors 890 are vibration sensors that are configured to register physical vibration, such as mechanical oscillation, occurring in and around asset 892. The assets 892 generally include any type of machinery or facility with components that perform measurable activities. In one embodiment, sensors 890 may be operably connected or affixed to assets 892 or otherwise configured to detect and monitor vibration (or other physical phenomena) occurring in or around the asset 892. The sensors 890 may produce time series signals of readings taken from the asset 892. The sensors 890 may be network-connected sensors. Assets 892 with network-connected sensors may be referred to as Internet of Things (IoT)-connected devices. The network connection of the sensors 890 and networks 860 may be wired or wireless.

In one embodiment, the sensors 890 include one or more vibration sensors, such as single- and/or multi-axial accelerometers, microphones, or piezoelectric vibration sensors. In one embodiment, the sensors 890 may also include (but are not limited to): a temperature sensor (such as a thermocouple or resistive temperature detector), a voltage sensor, a current sensor, a pressure sensor, a rotational speed sensor, a flow meter sensor, a speedometer or other speed sensor, an airspeed sensor or anemometer, an electromagnetic radiation sensor such as an antenna, a proximity sensor, a gyroscope, an inclinometer, a global positioning system (GPS) sensor, a fuel gauge, a torque sensor, a flex sensor, a nuclear radiation detector, or any of a wide variety of other sensors or transducers for generating electrical signals that represent sensed physical phenomena, for example physical phenomena occurring in or around asset 892.

In one embodiment, computer 805 is configured with logic, such as software modules, to collect readings from sensors 890 and store them as observations in a time series data structure such as a time series database. In one embodiment, the computer 805 polls sensors 890 to retrieve sensor telemetry readings. In one embodiment, the sensor telemetry readings may be a time series of vectors with sensed values for each of sensors 890. In one embodiment, the computer 805 passively receives sensor telemetry readings actively transmitted by sensors 890. In one embodiment, the computer 805 receives one or more collections, sets, or databases of sensor telemetry readings previously collected from sensors 890, for example from storage 835 or from remote computers 865.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computer cause the computer to:
record vibrations of a reference asset while the reference asset is operated based on a test pattern that sweeps over a range of workload for the reference asset;
determine cross power spectral densities between the recorded vibrations and the test pattern at intervals to identify resonance frequencies of the reference asset;
monitor vibrations of a target asset at the resonance frequencies with a machine learning model trained to generate estimated values at the resonance frequencies that are consistent with the reference asset;
detect resonant vibration amplification based on a dissimilarity between vibration values for the target asset at the resonance frequencies and the estimated values; and
generate an electronic alert that the target asset is undergoing the resonant vibration amplification.

2. The non-transitory computer-readable media of claim 1, further comprising instructions that when executed by at least the processor cause the computer to control the operation of the reference asset to cause the reference asset to operate according to the test pattern, wherein the test pattern is a sine sweep of load that covers a range of operation for the reference asset, and wherein the sine sweep changes in periodicity linearly over the course of the sweep.

3. The non-transitory computer-readable media of claim 1, wherein the instructions to identify the resonance frequencies of the reference asset further cause the computer to:
subdivide the frequency spectrum of the cross power spectral densities into a plurality of bins;
average a plurality of correlated frequencies in each bin over the intervals to produce averaged bins;
sample a time series from each averaged bin and determine amplitude for the bins from the sampled time series; and
select the bins which are in a top range of amplitude to be the resonance frequencies.

4. The non-transitory computer-readable media of claim 1, further comprising instructions that when executed by at least the processor cause the computer to:
(i) trigger, in response to the electronic alert, an adjustment to workload on the target asset to reduce stimulus to the resonance frequencies; or
(ii) generate, in response to the electronic alert, instructions for service to remediate the resonant vibration amplification.

5. The non-transitory computer-readable media of claim 1, wherein detecting resonant vibration amplification is based on an annular residual between kiviat plots of the vibration values and the estimated values satisfying a condition for detecting the resonant vibration amplification.

6. The non-transitory computer-readable media of claim 1, wherein detecting resonant vibration amplification is based on detecting an anomaly in a series of residuals between the vibration values and the estimated values for one of the resonance frequencies.

7. The non-transitory computer-readable media of claim 1, wherein the machine learning model implements a multivariate state estimation technique.

8. A computer-implemented method, comprising:
recording vibrations of a reference asset while the reference asset is operated based on a test pattern of duty cycle that sweeps over a range of workload for the reference asset;
determining cross power spectral densities between the recorded vibrations and the test pattern at intervals to identify resonance frequencies of the reference asset;
monitoring vibrations of a target asset at the resonance frequencies with a machine learning model trained to generate estimated values at the resonance frequencies that are consistent with the reference asset;
detecting resonant vibration amplification based on a dissimilarity between vibration values for the target asset at the resonance frequencies and the estimated values; and
generating an electronic alert that the target asset is undergoing the resonant vibration amplification.

9. The computer-implemented method of claim 8, wherein the test pattern is a sine sweep of load that covers a range of operation for the reference asset, wherein the sine sweep changes in periodicity over the course of the sweep.

10. The computer-implemented method of claim 8, wherein identifying the resonance frequencies of the reference asset further comprises:
subdividing the frequency spectrum of the cross power spectral densities into a plurality of bins;
averaging a plurality of correlated frequencies in each bin over the intervals to produce averaged bins;
sampling a time series from each averaged bin and determine amplitude for the bins from the sampled time series; and
selecting the bins which are in a top range of amplitude to be the resonance frequencies.

11. The computer-implemented method of claim 8, further comprising:
generating a kiviat tube of observations of the monitored vibrations; and
generating a graphical user interface that displays the kiviat tube, wherein the electronic alert causes an indication that resonant vibration amplification is detected to be displayed.

12. The computer-implemented method of claim 8, further comprising triggering, in response to the electronic alert, an adjustment to the workload on the target asset to reduce stimulus to the resonance frequencies.

13. The computer-implemented method of claim 8, wherein detecting resonant vibration amplification further comprises:
accessing monitored values of the monitored vibrations for an observation of the resonance frequencies and the estimated values for the observation of the resonance frequencies;
plotting the monitored values and the estimated values as a kiviat surface;
normalizing the kiviat surface to a unit circle of the estimated values;
generating an annular residual between the normalized monitored values and normalized estimated values; and
comparing the annular residual to a threshold for detecting the resonant vibration amplification.

14. The computer-implemented method of claim 8, wherein detecting resonant vibration amplification further comprises:
generating a series of residuals between monitored values of the monitored vibrations and the estimated values for one or more of the resonance frequencies; and
detecting an anomaly in the series of residuals with a sequential probability ratio test.

15. A computing system, comprising:
at least one processor connected to at least one memory;
one or more sensors configured to monitor vibrations of a target asset;
one or more non-transitory computer readable media including instructions stored thereon that when executed by at least the processor cause the computing system to:
monitor vibrations of a target asset at resonance frequencies of the target asset with a machine learning model, wherein the machine learning model is trained to generate estimated values at the resonance frequencies that are consistent with operation of the target asset with acceptable levels of resonant amplification vibration;
detect excessive resonant vibration amplification based on a dissimilarity between vibration values for the target asset at the resonance frequencies and the estimated values; and
generate an electronic alert that the target asset is undergoing the excessive resonant vibration amplification.

16. The computing system of claim 15, wherein the instructions further cause the computing system to:
control operation of the target asset to cause the target asset to operate according to a test pattern that sweeps over a range of workload for the reference asset, wherein the test pattern is a sine sweep of load that covers a range of operation for the reference asset;
record vibrations of the target asset while the target asset is operated based on the test pattern;
determine cross power spectral densities between the recorded vibrations and the test pattern at intervals to identify resonance frequencies of the reference asset; and
train the machine learning model to generate the estimated values based on time series of sampled values from the resonance frequencies, wherein the machine learning model learns by multivariate non-linear, non-parametric regression to generate the estimated values for one of the resonance frequencies from the sampled values for others of the resonance frequencies.

17. The computing system of claim 16, wherein identifying the resonance frequencies of the reference asset further comprises:
subdivide the frequency spectrum of the cross power spectral densities into a plurality of bins;
average the values in each bin over the intervals to produce averaged bins;
sample a time series from each bin and determine amplitude for the bins from the sampled time series; and
select the bins which are in a top range of amplitude to be the resonance frequencies.

18. The computing system of claim 16, wherein the instructions further cause the computing system to, in response to the electronic alert, control operation of the target asset to reduce stimulus to the resonance frequencies.

19. The computing system of claim 16, wherein the instructions for detecting resonant vibration amplification further cause the computing system to:
access monitored values of the monitored vibrations for an observation of the resonance frequencies and the estimated values for the observation of the resonance frequencies;
plot the monitored values and the estimated values into a kiviat surface;
normalize the kiviat surface to a unit circle of the estimated values;
generate an annular residual between the normalized monitored values and normalized estimated values; and
compare the annular residual to a threshold for detecting the resonant vibration amplification.

20. The computing system of claim 16, wherein the instructions for detecting resonant vibration amplification further cause the computing system to:
generating a series of residuals between monitored values of the monitored vibrations and the estimated values for one or more of the resonance frequencies; and
detecting an anomaly in the series of residuals with a sequential probability ratio test.
